(19) United States
(12) Patent Application Publication
(10) Pub. No.: US 2013/0204711 A1
(43) Pub. Date: Aug. 8, 2013

(54) METHOD AND SYSTEM FOR CREATING DATA-DRIVEN MULTIMEDIA ADVERTISEMENTS FOR DYNAMICALLY TARGETED AUDIENCE

(71) Applicant: UNITY WORKS! LLC, Bloomington, MN (US)

(72) Inventors: Bill C. WORTHEN, Bloomington, MN (US); Tim KOST, Bloomington, MN (US); Dean HILLESHEIM, Bloomington, MN (US); Thomas Pearce, Bloomington, MN (US); Andrew AWAIJANE, Bloomington, MN (US); Mark Ross, Bloomington, MN (US)

(73) Assignee: UNITY WORKS! LLC, Bloomington, MN (US)

(21) Appl. No.: 13/758,350

(22) Filed: Feb. 4, 2013

Related U.S. Application Data
(60) Provisional application No. 61/594,324, filed on Feb. 2, 2012.

(51) Int. Cl. G06Q 30/02

(52) U.S. Cl. CPC G06Q 30/0269
USPC 705/14.66; 705/26.61

(57) ABSTRACT

Method, system, and programs for creating data-driven multimedia advertisements for dynamically targeted audience. In one example, data feed from one or more sources is first received. Each source is associated with at least one product. The data feed from each source is analyzed to identify information related to any of the at least one product associated therewith. With respect to each product, a set of one or more campaign assembly packages (APs) are generated, each of which is directed to a target group, based on information characterizing the target group. With respect to each campaign AP, a pattern to be used for presenting the campaign AP to a target group is generated. The one or more campaign APs for each product and their corresponding patterns are stored in a storage for future use.

### CROSS-REFERENCE TO RELATED APPLICATIONS

The present application claims priority to U.S. Provisional Application Ser. No. 61/594,324 filed Feb. 2, 2012, entitled “Perpetually Learning System for Dynamically Creating Assembling and Delivering Data Driven Dynamically Targeted Video and Audio Web Page Advertising and Marketing Presentations,” which is incorporated herein by reference in its entirety.

### BACKGROUND

1. Technical Field

The present teaching relates to methods, systems, and programming for Internet services. Particularly, the present teaching relates to methods, systems, and programming for commerce advertising via the Internet.

2. Discussion of Technical Background

The Internet has become the primary tool for consumers to identify, compare, evaluate, and select services and/or products. Online advertising is now becoming an increasingly popular form for promoting products and/or services that uses the Internet and World Wide Web to deliver marketing messages to attract customers. Examples of online advertising include contextual advertisements on search engine result pages, banner advertisements, blogs, rich media advertisements, interstitial advertisements, online classified advertising, advertising networks, and e-mail marketing. One of the major challenges for Internet marketing is how to efficiently and dynamically assemble a marketing material related a particular product or service based on information from various sources in a manner that is most suitable to a specific target or target group and deliver the marketing material to the target or target group in an effective way.

### SUMMARY

The present teaching relates to methods, systems, and programming for Internet services. Particularly, the present teaching relates to methods, systems, and programming for commerce advertising via the Internet.

In one example, a method, implemented on a computer having at least one processor, storage, and a communication platform for online advertising with respect to target groups, is disclosed. In this example, data feed from one or more sources is first received. Each source is associated with at least one product. The data feed from each source is analyzed to identify information related to any of the at least one product associated therewith. With respect to each product, a set of one or more campaign assembly packages (APs) are generated, each of which is directed to a target group, based on information characterizing the target group. With respect to each campaign AP, a pattern to be used for presenting the campaign AP to a target group is generated. The one or more campaign APs for each product and their corresponding patterns are stored in a storage for future use.

In another example, a method, implemented on a computer having at least one processor, storage, and a communication platform for online advertising with respect to target groups, is disclosed. In this example, a request to access information related to a product is first received. The request is analyzed to identify information about a user associated with the request. One or more campaign APs associated with the product are retrieved. A campaign AP that is customized with respect to a target group to which the user is considered to belong is identified, determined based on the information about the user. A pattern for presenting the identified campaign AP is also identified based on the information about the user. An actionable indicator associated with the identified campaign AP is transmitted as a response to the request. The actionable indicator is to be used to activate the presentation of the identified campaign AP.

In still another example, a method, implemented on a computer having at least one processor, storage, and a communication platform for providing information, is disclosed. In this example, a request having a first, a second, and a third elements is first received. The first element corresponds to a first identification representing a locale; the second element corresponds to a second identification representing a first source to access information related to a product made available at a locale; the third element corresponds to a third identification representing a product. The first, second, and third elements are analyzed to identify a requested specific type of information related to a specific product made available at a specific locale. A specific source where the requested specific type of information is accessible is identified. The specific source provides different versions of requested specific information related to the specific product made available at the specific locale. Information associated with a second source where the request is sent is obtained. A version of the requested specific information to be made accessible customized for the request is determined based on the information associated with the second source.

In a different example, a system for online advertising with respect to target groups is disclosed. The system includes data feed processor, a constructor, and a storage. The data feed processor is configured to receive data feed from one or more sources, each of which is associated with at least one product. The data feed processor is also configured to analyze the data feed from each source to identify information related to any of the at least one product associated therewith. The constructor is configured to generate, with respect to each product, a set of one or more campaign APs, each of which is directed to a target group, based on information characterizing the target group. The constructor is further configured to generate, with respect to each campaign AP, a pattern to be used for presenting the campaign AP to a target group. The storage is configured to store the one or more campaign APs for each product and their corresponding patterns in a storage for future use.

In another different example, an integrated locator structure is disclosed. The integrated locator structure includes a first element, a second element, and a third element. The first element is configured to provide a first identification representing a locale. The second element is configured to provide a second identification representing a first source to access information related to a product made available at a locale. The third element is configured to provide a third identification representing a product. A combination of the first, second, and third elements in a pre-defined sequence identifies a specific source for information related to a specific product made available at a specific locale. The specific source provides different versions of information related to the specific product made available at the specific locale. A version to be accessible corresponding to a particular request is determined based on a second source from where the request is made.

Other concepts relate to software for implementing the method for online advertising with respect to target groups. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for online advertising with respect to target groups, where when the information is read by the machine, causes the machine to perform the following. In this example, data feed from one or more sources is first received. Each source is associated with at least one product. The data feed from each source is analyzed to identify information related to any of the at least one product associated therewith. With respect to each product, a set of one or more campaign APs are generated, each of which is directed to a target group, based on information characterizing the target group. With respect to each campaign AP, a pattern to be used for presenting the campaign AP to a target group is generated. The one or more campaign APs for each product and their corresponding patterns are stored in a storage for future use.

Additional novel features will be set forth in part in the description which follows, and in part will become apparent to those skilled in the art upon examination of the following and the accompanying drawings or may be learned by production or operation of the examples. The novel features of the present teaching may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an exemplary networked environment in which a system for creating data-driven multimedia advertisements for dynamically targeted audience (the system) may be implemented according to an embodiment of the present teaching;

FIG. 2 is a flowchart of an exemplary process of the system according to an embodiment of the present teaching;

FIG. 3 illustrates an exemplary simplified view of different sources of data feed collected by the system according to an embodiment of the present teaching;

FIG. 4 illustrates exemplary types of user-related data feed according to an embodiment of the present teaching;

FIG. 5 illustrates exemplary types of product-related data feed according to an embodiment of the present teaching;

FIG. 6 illustrates an exemplary system diagram of a behavior targeting module in the system according to an embodiment of the present teaching;

FIG. 7 is a flowchart of an exemplary process of the behavior targeting module according to an embodiment of the present teaching;

FIG. 8 illustrates an exemplary organization of campaign assembly packages (APs) generated by the system according to an embodiment of the present teaching;

FIG. 9 illustrates an exemplary assembly of a campaign AP according to an embodiment of the present teaching;

FIG. 10 illustrates an exemplary pattern associated with a campaign AP according to an embodiment of the present teaching;

FIG. 11 illustrates an exemplary presentation of content in a campaign AP to targeted audience in accordance with a corresponding pattern according to an embodiment of the present teaching;

FIG. 12 is a flowchart of an exemplary process of a campaign assembly package delivery module according to an embodiment of the present teaching;

FIG. 13 illustrates an exemplary delivery of categorized data in a campaign AP to targeted audience in the form of a multimedia webpage according to an embodiment of the present teaching;

FIG. 14 illustrates exemplary components on a multimedia webpage built based on a campaign AP and a corresponding pattern according to an embodiment of the present teaching;

FIG. 15 illustrates an exemplary multimedia webpage built based on a campaign AP and corresponding pattern according to an embodiment of the present teaching;

FIG. 16 illustrates an exemplary animated incentive path on a multimedia webpage according to an embodiment of the present teaching;

FIG. 17 illustrates another exemplary animated incentive path on a multimedia webpage according to an embodiment of the present teaching;

FIG. 18 illustrates an exemplary simplified URL according to an embodiment of the present teaching;

FIG. 19 illustrates an exemplary targeted e-mail with a simplified URL according to an embodiment of the present teaching;

FIGS. 20(a) and 20(b) illustrate an exemplary structure of simplified URLs for different promotions according to an embodiment of the present teaching; and

FIG. 21 illustrates a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teaching may be practiced without such details. In other instances, well known methods, procedures, systems, components, and/or circuitry have been described at a relatively high-level, without detail, in order to avoid unnecessarily obscuring aspects of the present teaching.

The present teaching is directed to systems and methods for creating data-driven multimedia advertisements for dynamically targeted audience. Multimedia advertisements include digital multimedia content, such as but not limited to, video, animation, photo, text, and audio, which can be organized and rendered in accordance with, e.g., a pattern for a particular product, a service, or a promotion of a product or service. A set of campaign assembly packages (APs), which may include the digital multimedia content and their corresponding patterns, may be created based on data feed(s) from sources associated with certain products or services thereof, e.g., manufacturers of goods, providers of services associated with the goods such as dealers. Such data feed may provide information with respect to promotion of certain product or service. The campaign APs and patterns may be dynamically created based on information associated with dynamically targeted audience that is collected and made available. The information associated with target audience includes, e.g., location of the audience, interests of the audience, profession or occupation of the audience, preferences or likings, profiles, or past historical activities, etc. Based on such information and the data feed, multimedia advertisements can be customized for each target audience group, whether it is related to a particular local population or even individuals. For example, if data feeds are from both a manufacturer of cars and from a dealership from a specific locale, the promotion information contained in both may be automatically combined to create a marketing advertisement for that particular locale with possibly, customizations specific to that locale as well. For instance, if a locale is in Northern part of the USA, the particular feature related to snow tire of a car being promoted may be highlighted or shown in length in the customized marketing advertisement for that locale. With the present teaching, promotions of products/services can be customized based on a targeted audience, determined either as a locale or a group of people or even individuals and delivered to the dynamically targeted audience to achieve enhanced marketing results. The existing digital content of campaign APs may also be modified and/or reused for building various multimedia advertisements in a fully automatic manner or with selected human intervention to increase the efficiency of the process.

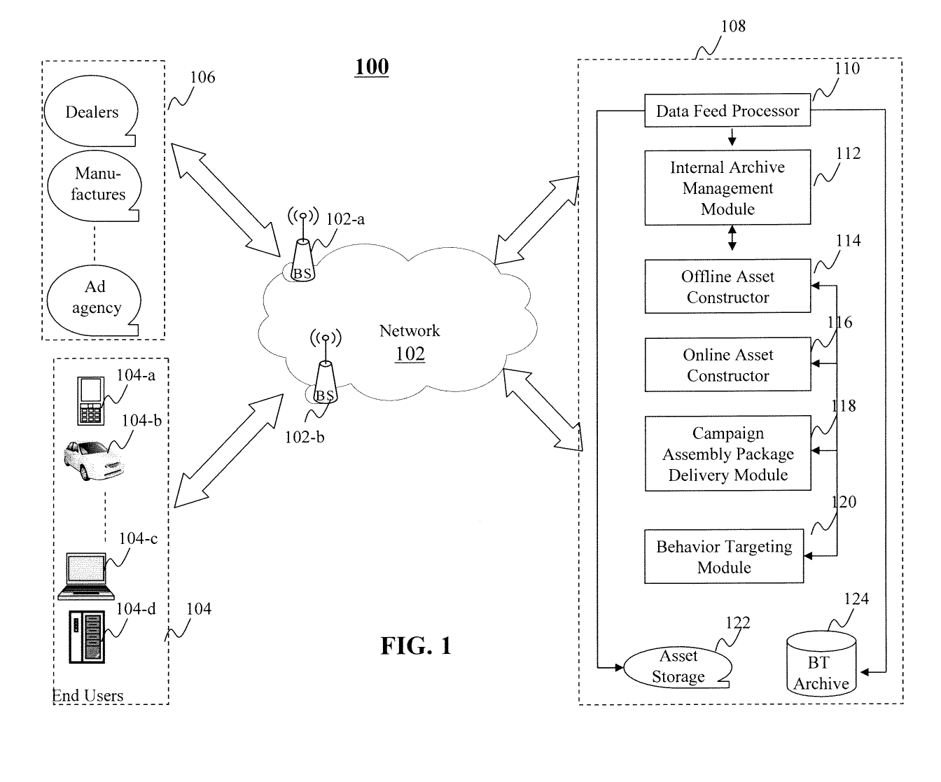

FIG. 1 illustrates an exemplary networked environment 100 in which a system for creating data-driven multimedia advertisements for dynamically targeted audience may be implemented according to an embodiment of the present teaching. In this embodiment, the networked environment 100 includes a network 102, end-users 104, product providers 106, and the system 108 for creating data-driven multimedia advertisements for dynamically targeted audience (hereinafter “the system”).

The network 102 may be a single network or a combination of different networks. For example, the network 102 may be a local area network (LAN), a wide area network (WAN), a public network, a private network, a proprietary network, a Public Telephone Switched Network (PSTN), the Internet, a wireless network, a virtual network, or any combination thereof. The network 102 may also include various network access points, e.g., wired or wireless access points such as base stations or Internet exchange points 102-a , . . . , 102-b, through which a data source may connect to the network 102 in order to transmit information via the network 102.

The end-users 104 include potential customers of products who are attached to the network 102 in a manner that allows them to view digital content in the multimedia advertisements, such as video clips, graphical text, audio, animation, and any other network deliverable content. The end-users 104 may be of different types such as users connected to the network 102 via desktop connections 104-d, users connected to the network via wireless connections such as through a laptop 104-c, a handheld device 104-a such as a tablet or a smart phone, or a built-in device in a motor vehicle 104-b. Each end-user 104 is a source where user-related data feed comes from and is associated with its user profile, such as but not limited to, age, marital status, profession, income, geographical location, hobby, family structure, etc., and user behavior, such as past online clicks on certain products, online transactions involving the users, or activities such as browsing certain web content, forwarding certain advertisement or product information to others, or contributing to online discussions on certain topics, etc.

The product providers 106 include, for example, product manufacturers 106-b, dealers 106-a, advertising agencies 106-c, and any other entities that provide the product, service, promotions and incentives of the product, advertising for the product, etc. Each product provider 106 is associated with one or more products and is a source where product-related data feed comes from. It is understood that although the terms “product” and “service” may have different meanings in some situations, in the present teaching, they are used interchangeably.

In this embodiment, the system 108 includes a data feed processor 110, an internal archive management module 112, an offline asset constructor 114, an online asset constructor 116, a campaign assembly package delivery module 118, a behavior targeting module 120, an asset storage 122, and a behavior targeting (BT) archive 124.

The data feed processor 110 in this embodiment receives data feed from different sources 106. Such data feed sources include information providers that provide information related to the markets or marketing such as behavior targeting related information, profiles of different social groups, profiles based on demographics, or information analytics derived from the commerce. Information from this category of data feed sources can be used to generate customized campaign APs, each of which may be directed to a specific target group. Upon receiving behavior targeting information, it may be analyzed, categorized, and then stored for future use in generating customized advertisement packages with respect to dynamically selected target groups. The data feed processor 110 may store such categorized data into the BT archive 124. Such stored behavior targeting information may be subsequently retrieved, e.g., by the offline asset constructor 114 to determine what assets from the asset storage 122 are to be included in each campaign AP to be generated.

The data feed sources 106 may also include sources that provide product information or product promotion information with respect to different products. This category of sources may include product manufacturers, product advertisers, product dealers, product distributors, or advertisement agencies. Information received from this category of data sources usually relates to one or more products and/or particular promotions directed to such products. The promotions from those data feed sources may be national, regional, and local promotions, depending on the data source. For example, a national promotion may be from a product manufacturer. A regional promotion may be from a chain dealer in a particular state. A local promotion may be from a specific dealership. In each promotion, the data feed may include information that not only describe the product being promoted (e.g., SUV Ford Explorer) and its features but also the information related to the promotion product such as the specific incentives associated therewith, specific geographical region/locale, or target group for the promotion (e.g., wild life lovers, male, and professionals). Thus, the promotion materials included in the data feed may also include videos, photographs, specifications and descriptions of the products, promotion details related to the products, campaign materials with respect to the products, and any other information relevant to the products. Based on the information received from the data feed sources 106, the data feed processor 110 may either store the received information in the asset storage 122, based on, e.g., different categories for each product or store the data into different types for each data feed through the internal archive management module 112 or store the information in the BT archive 124. In some embodiments, information about a product from the data feed is associated with, for example, model and/or manufacturer of the product, year in which the product is made, locale in which the product is sold, inventory availability of the product, features of the product, and price range of the product.

The offline asset constructor 114 in this embodiment constructs campaign APs based on the data received and categorized by the data feed processor 110 as well as information stored in the BT archive 124. In this embodiment, each campaign AP is a customized advertisement package generated for a particular target audience, which can be a group of potential buyers located in a particular region/locale, a group of people who have similar profiles, a group of potential buyers on a particular type of device, etc.. Each campaign AP may include a collection of digital content with an underlying product, information associated with the product, or promotion information, selected based on, e.g., intended target audience specified or behavior targeting information stored in the BT archive 124. In some embodiments, the content in a campaign AP includes, for example, video clips, photos, animations, digital graphic elements, thumbnail icons, background images, color palette information, metadata information, and product information. The content to be included in each campaign AP may be selected based on the behavior targeting information or profiling information retrieved from the BT archive 124, based on the information in the promotion data feed that may specify, e.g., intended target audience. The offline asset constructor 114 may also construct a pattern for presenting a campaign AP. In this embodiment, the pattern includes information for controlling the presentation of digital content in a campaign AP. In other words, the pattern may be a collection of instruction that makes the rendering of a campaign AP possible. In some embodiments, the pattern includes information, such as but not limited to, size of a display area in which the content is to be presented, location and dimension in the display area in which each piece of content is to be presented, timing at which each piece of content is to be presented, duration for which each piece of content is to be presented, font to be used to present each piece of content, and color to be used to present each piece of content.

In this embodiment, the generation of the campaign APs and patterns may be performed taking into consideration of the characterization of targeted audience to whom the multimedia advertisements are presented. For example, if safety measure of a car is important to targets known as ones having children, then video clips of crash test of a car and other content highlighting the safety features of the car may be picked up from the data feed of the car manufacturer and constructed into a campaign AP directed to the target group. Also, the pattern of presenting the campaign AP may be constructed to include the suitable background color, font size, video clip size, and location and duration to emphasis the safety features of the car when a multimedia advertisement built based upon the campaign AP is presented to the targeted audience.

The online asset constructor 116 may perform the same processing as the offline asset constructor 114 but with data arriving in real time in data feed. The online asset constructor 116 may construct campaign APs and patterns in real time based on the data feed and the characterization of the targeted group. The campaign APs and corresponding patterns constructed by the offline assert constructor 114 and the online assert constructor 116 may be stored in a storage for future use.

The campaign assembly package delivery module 118 in this embodiment delivers digital content in the campaign APs in accordance with the corresponding pattern to the end-users 104 in the form of multimedia advertisements in response to a request for information regarding a particular product or service. In this embodiment, the multimedia advertisements are delivered to dynamically targeted audience based on a matching between the characterization of a target group to which the end-user 104 belongs and the characterization of the campaign AP and its corresponding pattern. As mentioned above, as each campaign AP and its corresponding pattern may be constructed taking into consideration of the characterization of a particular target group, when the information about an end-user 104, such, such as user profile and behavior, is known to the campaign assembly package delivery module 118, it may search existing campaign APs and corresponding patterns to select a campaign AP for which the information about the end-user 104 is the most consistent with the characterization of the target group associated with the selected campaign AP. For example, when the location of a potential buyer of a car is known, the campaign assembly package delivery module 118 may select a campaign AP and corresponding pattern constructed based on the car information from a particular dealer who is in the area where the potential buyer lives and deliver an advertisement, including digital content, e.g., ongoing promotion of the car offered by the dealer, in the selected campaign AP, to the potential buyer.

The behavior targeting module 120 in this embodiment identifies behavior of the end-users 104 and targets the campaign APs and patterns appropriately. As mentioned before, behavior targeting and profiling information may be specified in a data feed. A particular target group may be already specified in the data feed or created by the behavior targeting module 120 by analyzing any user-related data from the data feed. The behavior targeting module 120 may receive data feed related to the end-users 104 and analyze the user-related data feed to generate behavior targeting information. Based on the result of the analyzing, target groups may be created by the behavior targeting module 120. The behavior targeting module 120 may further generate a characterization for each target group that describes the preference of the targets within the group. The target groups and the characterizations thereof may be used in generating the campaign APs and corresponding patterns in a manner that is appropriate with respect to the characterizations of the target groups.

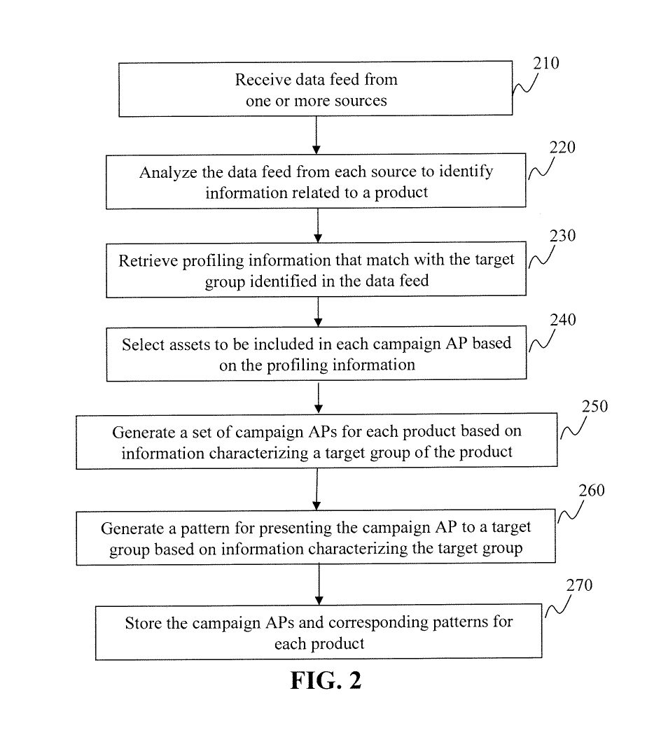

FIG. 2 is a flowchart of an exemplary process of the system 108 according to an embodiment of the present teaching. Starting from step 210, data feed is received from various sources, including information providers, product manufacturers, product distributors, product dealer, advertisers, or even government. As discussed above, an information provider may provide behavior targeting information. Data feed related to products or promotion thereof may be from a product provider for one or more products, such as but not limited to, manufacturers, dealers, distributors, vendors, and advertising agencies. At step 220, the received data feed from each source is analyzed to identify relevant information and store the information in appropriate data storages. For example, as discussed with respect to FIG. 1, behavior targeting information may be identified from the data feed and stored in BT archive 124. Information from data feed related to products and promotions thereof may be stored in the asset storage 122. To generate a set of campaign APs for each promoted product, the behavior targeting information or profiling information that matches with the intended target group of the promotion is retrieved at step 230. To construct campaign APs, assets to be included in each AP are selected, at step 240, based on the behavior targeting information or appropriate profiling information. For example, if a car being promoted is Ford Explorer and the intended target groups are audience in Michigan (cold climate) and Florida (warm climate), appropriate regional profiling information for both regions may be retrieved from BT archive 124 and used to determine which video clips to be included in their corresponding campaign APs. In this example, the profile for Michigan may indicate that audience in that region care quite a bit about the snow tire feature of any car being sold while the profile for Florida audience may indicate that potential buyers there do not care about snow tires but do care about sun roofs in cars. Such regional profiling information may then be used to select appropriate video footages in the asset storage 122 about Ford Explorer and the footages related to snow tire feature may be used to construct the campaign AP for the Michigan audience but not for the campaign AP for the Florida audience. At the same time, the footages related to sun roofs may be used for both campaign APs. Based on the selected assets for each campaign AP, multiple campaign APs are generated for the promoted product at step 250. Each campaign AP is constructed to be directed to a particular target group. As mentioned before, each campaign AP includes a collection of digital content associated with an underlying product, service, or promotion. Such a campaign AP may be viewed as a depository of assets. For each such campaign AP, a pattern is then generated, at step 260, which provides information related to how to present all assets included in the campaign AP to a user who falls within the target group aimed by the AP. As mentioned before, each pattern may be a collection of instruction that makes the rendering of the corresponding campaign AP possible. The pattern associated with each campaign AP directed to a target group may also be constructed based on information characterizing that target group. Following the same example provided above, the pattern associated with the campaign AP for Michigan audience, the video footage for sun roof may be rendered with a shorter duration while the pattern for the campaign AP for Florida audience, the video footage showing the sun roof feature of Ford Explorer may be rendered for a longer period of time with, e.g., special effect to further attract the audience in Florida. At step 270, the generated campaign APs and their corresponding patterns for each product are stored for future use.

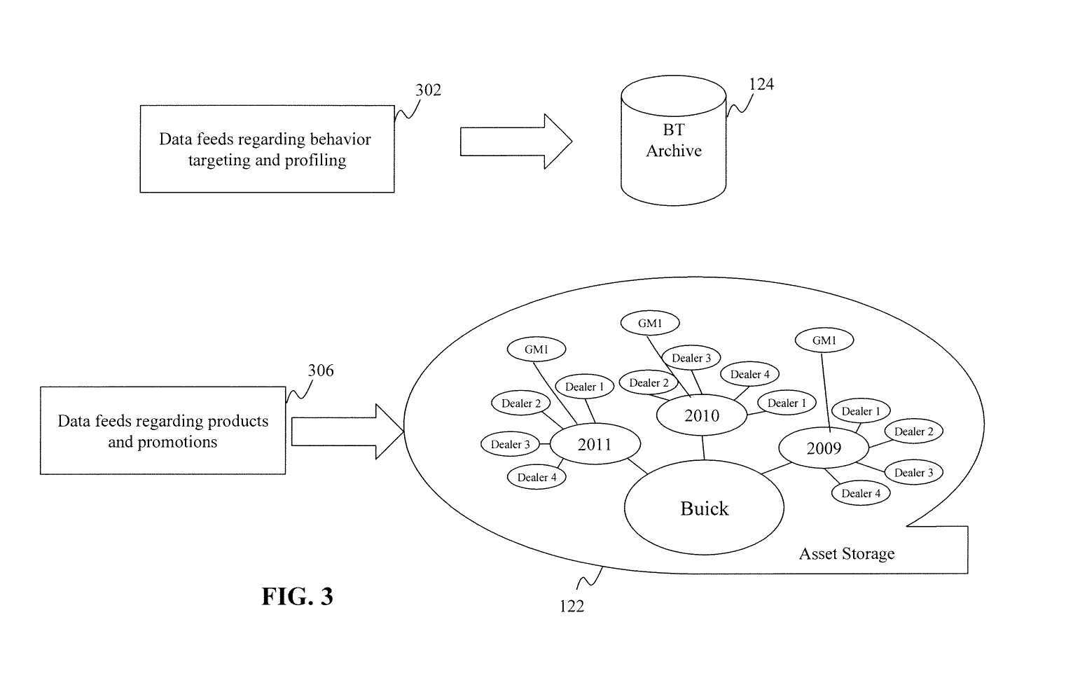

FIG. 3 illustrates an exemplary simplified view of different sources of data feed collected by the system 108 according to an embodiment of the present teaching. Data feed regarding behavior targeting and profiling 302 is collected in the BT archive 124 and used as a means for generating campaign APs for different target groups and for selecting the appropriate campaign APs for delivering advertisements to dynamically targeted audience. Any data collected regarding behavior targeting and profiling, such as behavior targeting related information, profiles of different social groups, profiles based on demographics, or information analytics derived from the commerce, may be stored in the BT archive 124 The data feed regarding behavior targeting and profiling 302 may come from a variety of locations including third-party marketing information providers, social networking sites, dealer sites, or any other entities that gather information regarding markets and marketing. In addition, the online asset constructor 116 and the offline asset constructors 114 may obtain product-related data feed from product providers to construct the asset storage 122 which includes data for any particular product. In some embodiments, the collected data may be sorted into categories. As shown in FIG. 3, for example, the assert storage 122 may include a database for Buick cars. The database may be divided into sections for each year model of Buick, and each dealer. Digital content, e.g., video and graphics relevant to each dealer and year of Buick cars may be placed in the relevant part of the database, and may be used as initial materials/assets to construct the corresponding campaign APs.

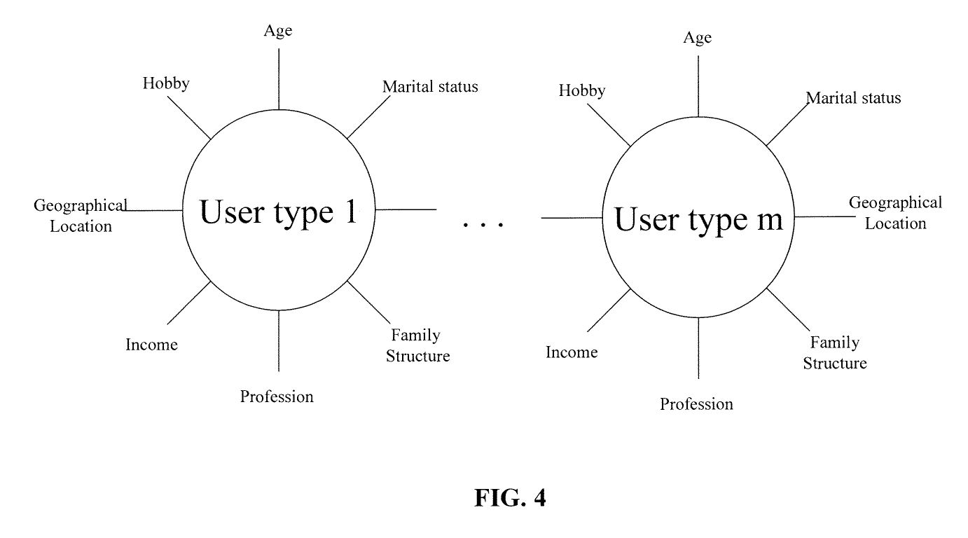

FIG. 4 illustrates exemplary types of user-related data feed according to an embodiment of the present teaching. Behavior targeting and profiling information may include different user types based on user profiling as target groups for marketing. Each user type may be defined by one or more attributes related to the users. The user-related data includes various pieces of information regarding an end-user. These pieces of information may be used for generating campaign APs for different target groups and for selecting the appropriate campaign APs for delivering advertisements to dynamically targeted audience. For example, video marketing materials for a married customer may be quite different from the materials for a single customer, even for the same product. As shown in FIG. 4, based on various user attributes, such as but not limited to, age, marital status, profession, income, geographical location, hobby, family structure, etc., each user may be categorized into a particular user type for selecting and customizing an appropriate campaign AP and corresponding pattern.

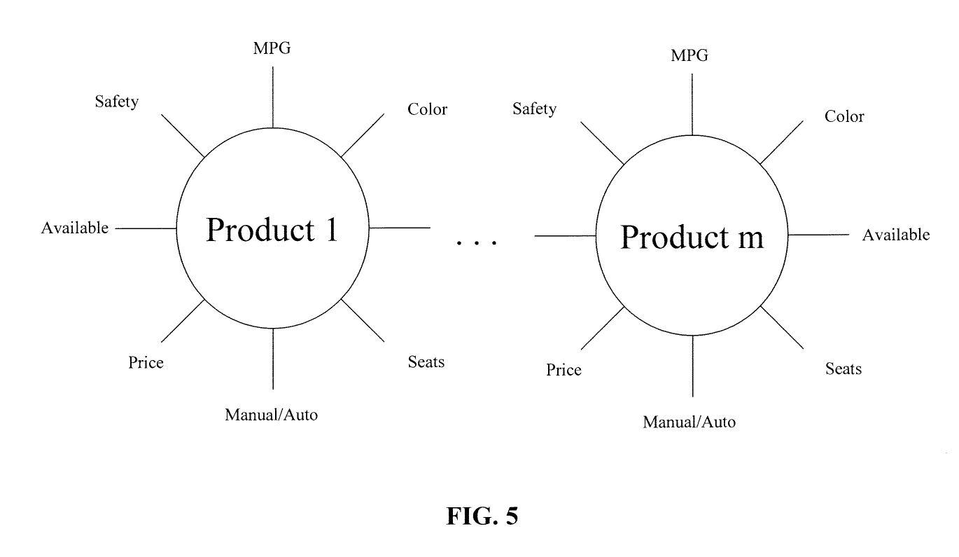

FIG. 5 illustrates exemplary types of product-related data feed according to an embodiment of the present teaching. The product-related data includes various pieces of information regarding a particular product. These pieces of information may be used to construct a campaign AP for a product, service, or promotion. For example, if a user has children, the campaign AP may emphasize product information relevant to having children, such as the number of seats in a car. As shown in FIG. 5, product-related data feed for a car may include information such as miles-per-gallon (MPG), color, number of seats, manual or auto transmission, price, inventory availability, safety, etc.

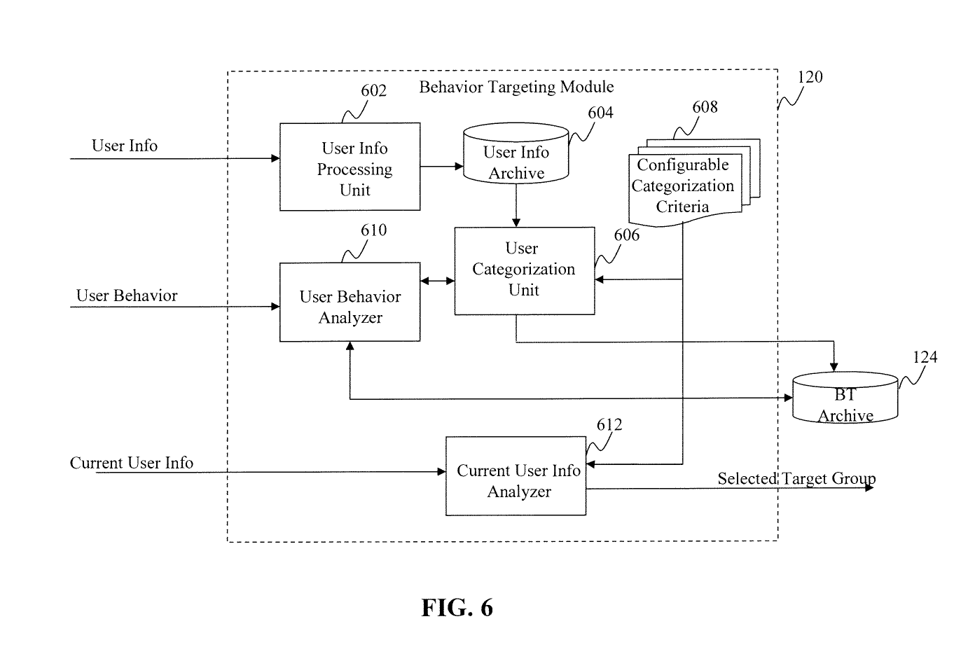

FIG. 6 illustrates an exemplary system diagram of a behavior targeting module according to an embodiment of the present teaching. In this embodiment, the behavior targeting module 120 is configured to generate customized target groups/user types with group characteristics based on user data feed. With the behavior targeting module 120, when the data feed regarding users is received, a user information processing unit 602 may analyze the received user information. The user information may include user attributes, such as age, marital status, profession, income, geographical location, hobby, family structure, etc. Such information and analyzed result may be stored in a user information archive 604. Utilizing such stored information, a user categorization unit 606 may group user data into groups, each of which may represent a group of users who share certain characteristics, features, interests, or preferences. The grouping may be carried out based on some categorization criteria 608, which may be configured or re-configured by, e.g., a system administrator based on needs.

In addition, various types of information related to user behavior may also be collected and analyzed by a user behavior analyzer 610. Such user behavior information may include past online clicks on certain products, online transactions involving the users, or activities such as browsing certain web content, forwarding certain advertisement or product information to others (that shows interest), or contributing to online discussions on certain topics, etc. Such behavior information feed may be combined with user categorization information to link certain behavior, liking, or preferences with certain groups of users. In other words, customized target groups/user types with group characteristics may be created and stored in the BT archive 124.

The behavior targeting module 120 is also configured to target a new user by recognizing which user group the new user may belong to in order to select the suitable campaign AP for any user. For example, when information about a new user is received, a current user information analyzer 612 may analyze the new user's information in light of the user groups and their recorded preferences archived in the BT archive 124. The behavior targeting module 120 then may select a group to which most likely the new user belongs so that multimedia advertisements may be targeted based on the likings or preferences known to be associated with that group. For example, if it is found that women as mothers (this is a user group) often prefer to buying vans, rather than sports cars, with strong safety measures and TV screen in the van, when a new user is recognized as a mother, advertisements related to a van may be recommended or displayed to the new user.

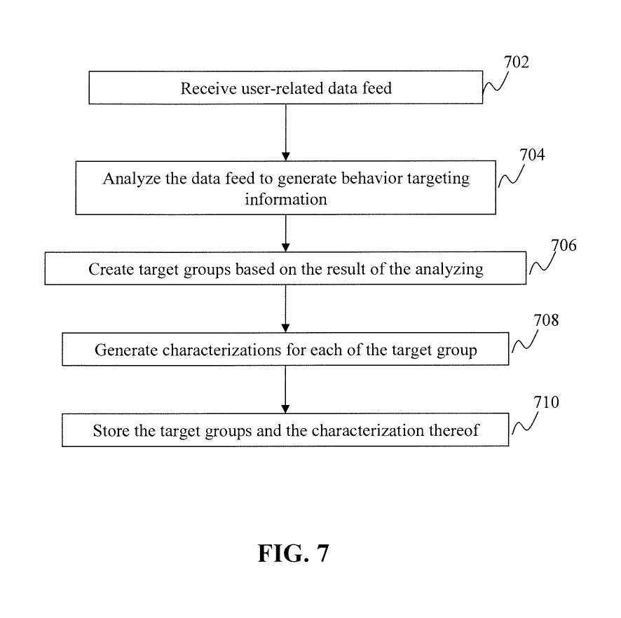

FIG. 7 is a flowchart of an exemplary process of the behavior targeting module 120 according to an embodiment of the present teaching. Starting from step 702, user-related data feed is received. The user-related data feed includes, for example, user attributes such as sex, age, profession, etc., and user behavior information such as online transactions, activities, discussions, etc. At step 704, the user-related data feed is analyzed to generate behavior targeting information, such as shared characteristics, features, interests, or preferences for a group of users. Moving to step 706, target groups are created based on the result of the analyzing. For example, the grouping may be carried out based on some categorization criteria, which can be configured or re-configured by, e.g., a system administrator, based on needs. At step 708, a characterization is generated for each target group. The characterization describes the preferences of the targets within the group. At step 710, the target groups and their characterizations are stored for future use in generating and selecting campaign APs and corresponding patterns in a manner that is appropriate with respect to the characterization of the target group. In one example, each target group may be associated with one or more tags, which contain information formulated in such a way as to be able to be compared to a unique identifier associated with each campaign AP.

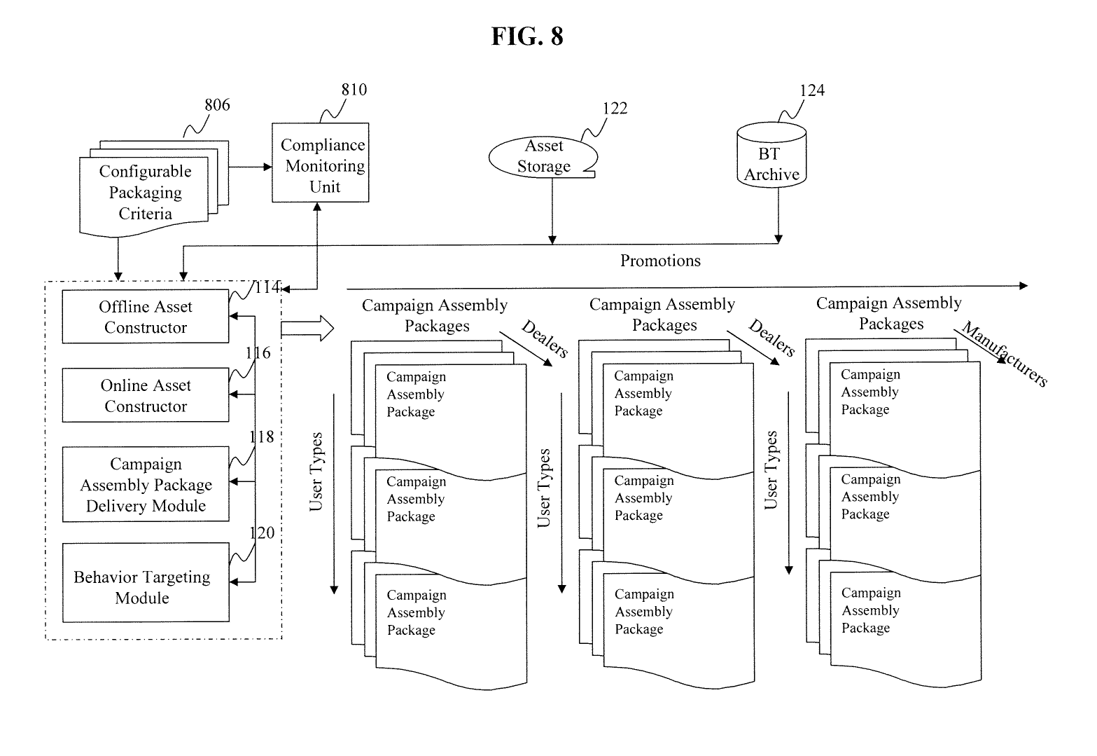

FIG. 8 illustrates an exemplary organization of campaign APs generated by the system 108 according to an embodiment of the present teaching. In this embodiment, the campaign APs are arranged in an array according to various properties of each campaign AP. Thus, campaign APs may be constructed for, e.g., each product provider (e.g., dealer, manufacturer), each user type (target group), each promotion, each product/service, and for any other relevant variable/dimension. This may result in is a large number of campaign APs, each of which corresponding to a product provider (e.g., dealer, manufacturer), a user type, a product, a product promotion, etc. Therefore, when a request is made by a user, the campaign assembly package delivery module 118 may rapidly select the appropriate campaign AP from all the generated campaign APs based on, for example, the target group to which the user belongs as stored in the BT archive 124. Then, the digital content of the selected campaign AP may be presented in accordance with the corresponding pattern to the user as a multimedia advertisement.

In this embodiment, product-related data feed, such as data feed regarding products and promotions from, for example, dealers, manufacturers, advertising agencies, etc., are stored in the assert storage 122 as initial materials to be used in constructing campaign APs by the offline and/or online asset constructors 114, 116. In addition, behavior targeting and profiling information stored in the BT archive 124 may be also used by the offline asset constructor 114 in creating campaign APs for specific target groups. In determining how to construct campaign APs, in addition to the initial materials and behavior targeting and profiling information from the data feed, the offline and/or online asset constructors 114, 116 may also operate based on configurable packaging criteria 806 to determine how the campaign APs as well as their corresponding patterns should be generated. The configurable packaging criteria 806 may be set to provide rules or instructions that are used to guide what assets to be used in a campaign AP, how different pieces of assets to be included in a campaign AP should be presented and in what manner. The configurable packaging criteria 806 may be provided and may also be re-configured over time when the need arises. The re-configuration may be performed by either a human administrator or by a machine automatically. Changes made to the configurable packaging criteria 806 during re-configuration may be determined based on a variety of information such as feedback about past campaign APs and the display thereof.

In some embodiments, the configurable packaging criteria 806 may include a set of rules or conditions that provide guidance in creating campaign APs based on the materials/assets from the data feed of products 802 and the data feed of promotions 804. In other words, the rules/conditions may specify certain available materials/assets as digital content in a particular campaign AP. In some embodiments, the rules/conditions may specify that certain materials/assets from the data feed 802, 804 as required content, i.e., that has to be included in a campaign AP. In some embodiments, some materials/assets may be set as required content by the rules/conditions in accordance with, for example, law and regulations, commercial requirements, and consumer needs. In one example, the price of a car may be one of the required piece of content in any campaign APs. This requirement may be from the government or from a particular car manufacturer. In another example, the logo of a car manufacturer may be another piece of required content in any campaign APs. In yet another example, certain features of a car may be set as required content that has to be included in any campaign APs that are to be delivered in a state that requires those features to be disclosed per its state law. In addition to required content, the rules/conditions may also specify some other materials/assets as optional content that may be included in each campaign AP based on different conditions, including user types, promotions, dealers, manufacturers, etc. For example, video clips about children-safety features of a car may be set as optional content, particularly for any campaign APs that are directed to potential buyers who are mothers. It is understood that, for optional content, the rules/conditions as specified in the configurable packaging criteria 806 may also set priorities for each piece of the optional content in order to select appropriate content or assets for a campaign AP in a certain way. For example, certain features of cars may be specified as linked to certain climate, e.g., snow tires are linked to cold climate. According to such linkage, it may be further specified in the configurable criteria 806 that for a locale that has cold climate, feature related to snow tires has a higher priority. When such criteria are applied, a customized video clip featuring a van with snow tires in a state (locale or region) with cold climate will then be generated by including the footage focusing on the snow tire features because such assets have a higher priority given the conditions specified in the configurable packaging criteria 806. In some embodiments, the priorities may also be set based on the characterizations of target groups. For example, content related to the number of seats in a car, safety-features, and MPG may have a high priority for campaign APs directed to mothers, while the same content may be assigned with a low priority for campaign APs directed to teenagers.

The configurable packaging criteria 806 may also be applied in generating patterns for each campaign AP. In addition to content selected for composing a campaign AP, the manner in which the digital content are organized and presented also reflect the priority or importance of each piece of assets included in the campaign AP. For example, a specific rule in the configurable packaging criteria 806 may require that the logo of a car manufacturer has to be displayed on the top-left corner of the display window. In another example, an image showing a “0% APR” offer for a particular car may be popped up once a video of the car starts to play and may be zoomed in and out to highlight it. Yet another example of prioritizing the rendering of a customized campaign AP directed to a woman who is a mother is that a video clip that shows the superior safety measure of a promotion car takes a higher priority than a campaign AP that is directed to a teenager.

In this embodiment, a compliance monitoring unit 810 may be incorporated to monitor the degree of compliance with the configurable packaging criteria 806 in creating campaign APs. A threshold of compliance may be predetermined, for example, by a system administrator or a campaign manager based on specific requirements from the manufacturers, dealers, advertising agencies, etc. In one example, Ford may be very strict to the compliance of rules/conditions in creating any campaign APs for national promotions of Ford cars, and thus, a high threshold, e.g., 98%, may be set by the system administrator or the campaign manager. In another example, a local deader may be less strict to the compliance of rules/conditions in creating campaign APs for a local promotion, and thus, a low threshold, e.g., 50%, may be set. The compliance monitoring unit 810 may automatically check each created campaign AP and determine, for example, how much content in a campaign AP complies with the rules/conditions set forth in the configurable packaging criteria 806. In some embodiments, content that is not complied with the rules/conditions may be highlighted by the compliance monitoring unit 810 and requested for human intervention. A system administrator or a campaign manager may check all the highlighted content and determine whether the created campaign AP needs to be modified or recreated.

As mentioned before, the campaign APs and patterns may be generated in different modes. In some embodiments, the offline asset constructor 114 may generate campaign APs and corresponding patterns based on offline data (e.g., various data feed from manufacturers, dealers, etc.) available to the system 108. Those campaign APs and patterns may be also generated based on the behavior targeting and profiling information stored in the BT archive 124 provided by the behavior targeting module 120 and/or specified in the data feed. To generate a set of campaign APs for each promoted product, the behavior targeting information or profiling information that matches with the intended target group of the promotion may be retrieved from the BT archive 124. To construct campaign APs, materials/assets to be included in each campaign AP are selected based on the behavior targeting information or appropriate profiling information of a region/locale or a social group. For example, if a car being promoted is Ford Explorer and the intended target groups are audience in Michigan (cold climate) and Florida (warm climate), appropriate regional profiling information for both regions may be retrieved from BT archive 124 and used to determine which video clips to be included in their corresponding campaign APs. In this example, the profile for Michigan may indicate that audience in that region care quite a bit about the snow tire feature of any car being sold while the profile for Florida audience may indicate that potential buyers there do not care about snow tires but do care about sun roofs in cars. Such regional profiling information may then be used to select appropriate video footages in the asset storage 122 about Ford Explorer and the footages related to snow tire feature may be used to construct the campaign AP for the Michigan audience but not for the campaign AP for the Florida audience. In another example, based on the profiling information of social groups stored in the BT archive 124, the offline asset constructor 114 may construct campaign APs for each user group/type because their preference and likings are known. For example, if there is a user group/type known to be mothers with young children, and if it is recorded in the BT archive 124 that they tend to purchase vans with good safety measures and entertainment amenities (profiling information), in this case, the offline asset constructor 114 may generate a set of campaign APs for a van with content about various safety measures and good entertainment features.

In some embodiments, when the campaign APs generated offline do not quite fit the preference of a new user, e.g., the new user does not quite fit into any of the known target groups/user types, the online asset constructor 116 may be invoked to dynamically construct a campaign AP on the fly based on the information about the user. For example, if the user is known, e.g., based on his personal profile of some purchase history of cars, to like sports cars, the online asset constructor 116 may dynamically compose a new campaign AP and its corresponding pattern, featuring a promotion on a sports car from a dealer residing close to where the new user lives. In some embodiments, content of existing campaign APs may be modified, reorganized, and reused to create new campaign APs by the online asset constructor 116. If no suitable existing campaign AP is identified, depending on the similarity between the characterization of the target group to which the new user belongs and the characterization associated with the existing campaign APs, content in an existing campaign AP may be modified and reorganized for the new user or a new campaign AP may be created. It is understood that these processes may be performed either in a fully automatic manner or with selected human intervention to increase the efficiency.

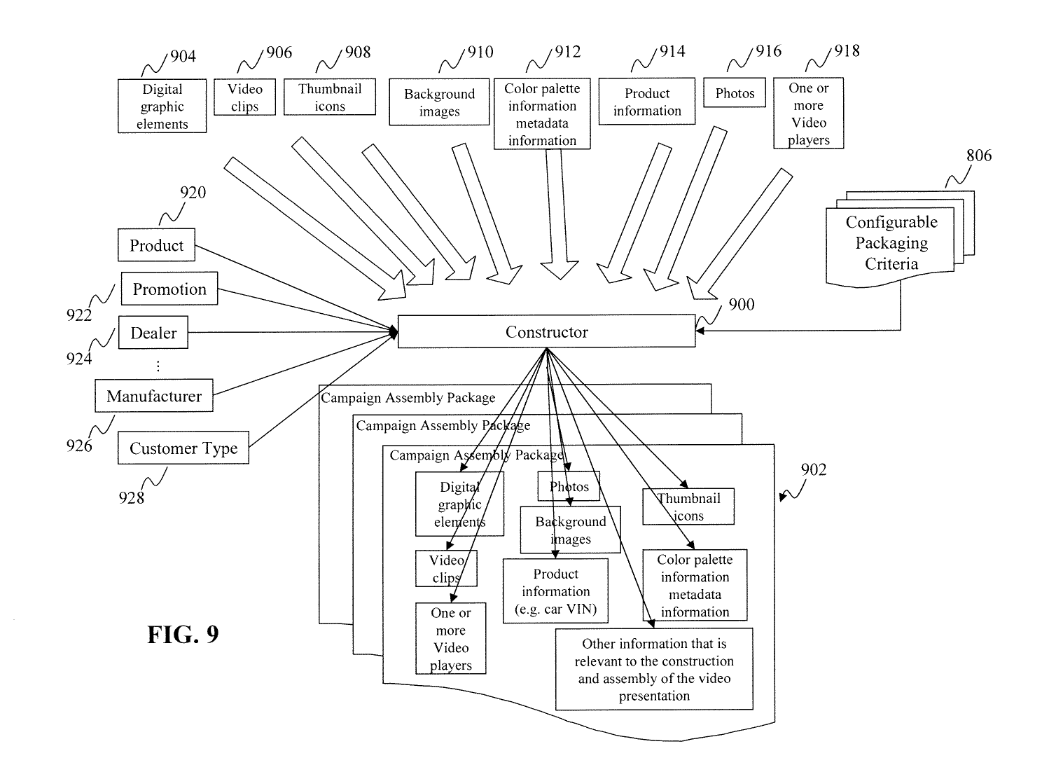

FIG. 9 illustrates an exemplary assembly of a campaign AP according to an embodiment of the present teaching. A constructor 900 (the offline asset constructor 114 and/or the online asset constructor 116) may receive data feed as initial materials/assets to construct campaign APs 902. As shown in FIG. 9, the initial materials/assets include, for example, digital graphic elements 904, video clips 906, thumbnail icons 908, background images 910, color palette information and metadata information 912, product information 914, photos 916, and one or more video players 918. The materials/assets 904-918 may be selected and assembled to construct campaign APs 902 in accordance with the configurable packaging criteria 806 for each variable/dimension. The variable/dimension includes, for example, the product 920, promotion 922, dealer 924, manufacturer 926, and customer type 928. As mentioned before, behavior targeting and profiling information, such as the profile of a user group or a region/locale, either received as part of the data feed or created by the behavior targeting module 120, may be also used by the constructor 900 in creating campaign APs 902 for specific target groups. In addition, each campaign AP 902 may also include placeholder buttons, which may be instantiated based on the individualization of the underlying users. For example, if a user is known to be a stay-home mother, a button may be instantiated as a “Chat” button because this will give the user the benefit of having someone on the phone to help her to understand a particular promotion on a car that the user is most likely interested in. If the user is a working man, the button, although may be located at the same location of the display, may be instantiated as a button that, once clicked, may lead to the specific detailed description of the functions and specification associated with the car presented on the display. The rationale may be that a man usually prefers to digging into details of the cars and likes to have more descriptions while he is busy working.

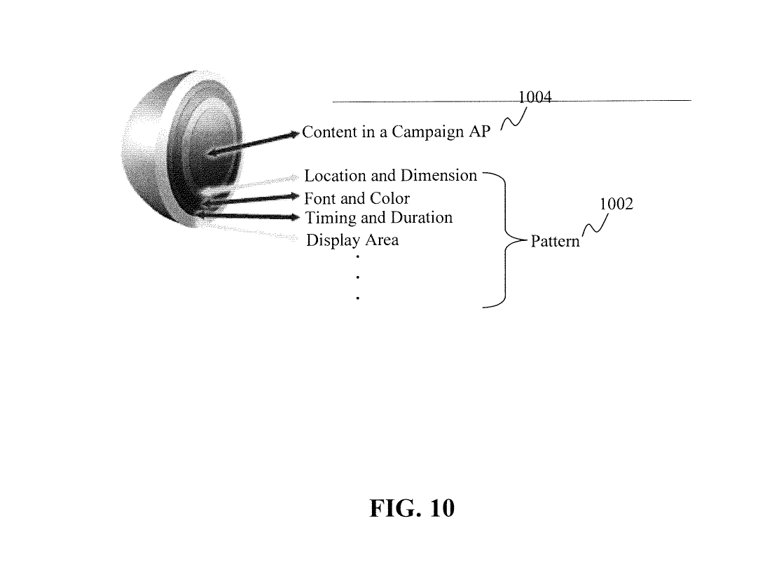

To organize and present the digital content, each campaign AP 902 may be associated with a pattern. FIG. 10 illustrates an exemplary pattern associated with a campaign AP. In this embodiment, the pattern 1002 includes information for controlling the presentation of the content in a campaign AP 1004. In other words, the pattern 1002 may be a collection of instruction that makes the rendering of the campaign AP 1004 possible. In some embodiments, the pattern 1002 includes information, such as but not limited to, size of a display area in which the digital content is to be presented, location and dimension in the display area in which each piece of content is to be presented, timing at which each of the content is to be presented, duration for which each piece of content is to be presented, font to be used to present each piece of content, and color to be used to present each piece of content.

As mentioned before, the constructor 900 may be configured to generate the pattern 1002 that ties different pieces of information (video, text, audio) of the campaign AP 1004 in a manner that spans in terms of space and time. For instance, in each campaign AP, multiple video presentations may be included, each of which may occupy different real estate space on a display, and each may be displayed at a controlled timing, and together they create a presentation that maximizes the effectiveness of the presentation. Also, the pattern 1002 may be created based on user groups/types. For example, if safety measure is important to targets known as ones having children, then the information regarding the display color, font size, duration of video displaying, etc., may be specified in the pattern 1002 to emphasis and highlight content related to safety feature of the product in the multimedia advertisements.

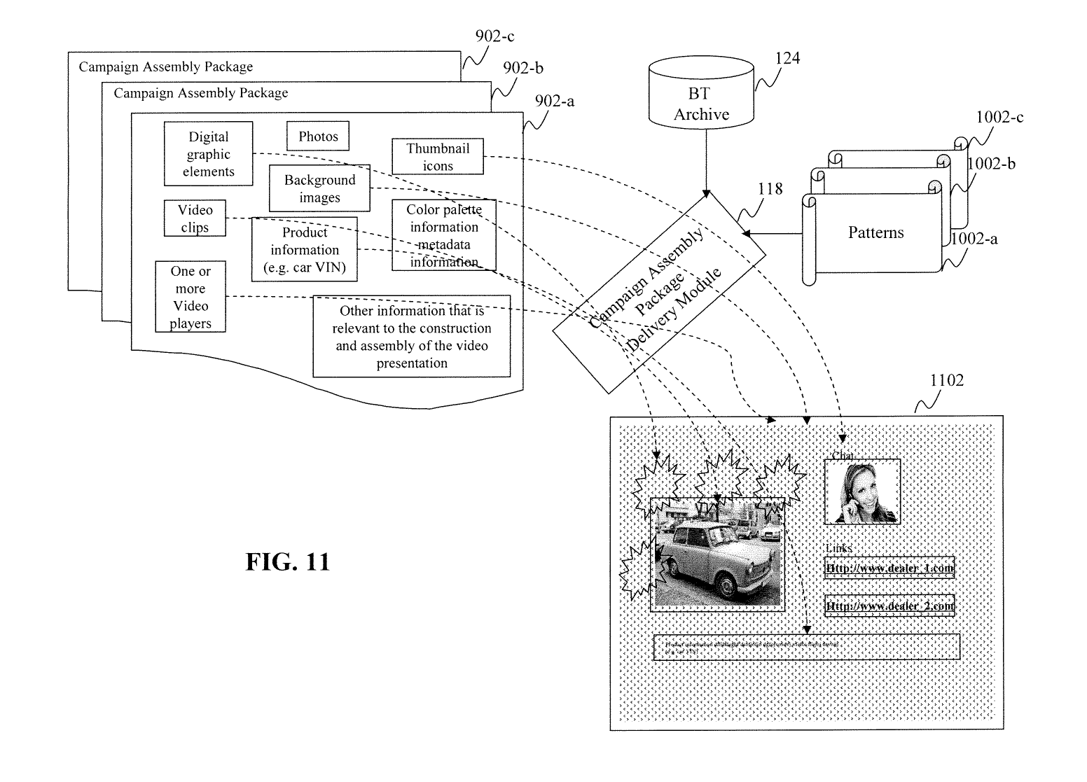

FIG. 11 illustrates an exemplary presentation of content in a campaign AP to targeted audience in accordance with a corresponding pattern according to an embodiment of the present teaching. In this embodiment, based on the request from a user to access a product, service, or promotion, the campaign assembly package delivery module 118 may obtain information regarding the user from the BT archive 124. User information may already be processed and stored in the BT archive 124, indicating the characterization of a target group to which the user belongs. Based on the user information, the campaign assembly package delivery module 118 may retrieve one or more campaign APs 902-a, 902-b, 902-c associated with the product requested by the user. As mentioned before, campaign APs 902-a, 902-b, 902-c may have been generated for the product, service, or promotion and stored in an asset storage. The campaign assembly package delivery module 118 then may identify a campaign AP 902-a that is customized with respect to the target group to which the user belongs. In order to present the content in the identified campaign AP 902-a, a corresponding pattern 1002-a may be also identified based on the information about the user. In this embodiment, the content in the identified campaign AP 902-a then may be presented in accordance with the identified pattern 1002-a as a multimedia advertisement, such as a webpage 1102.

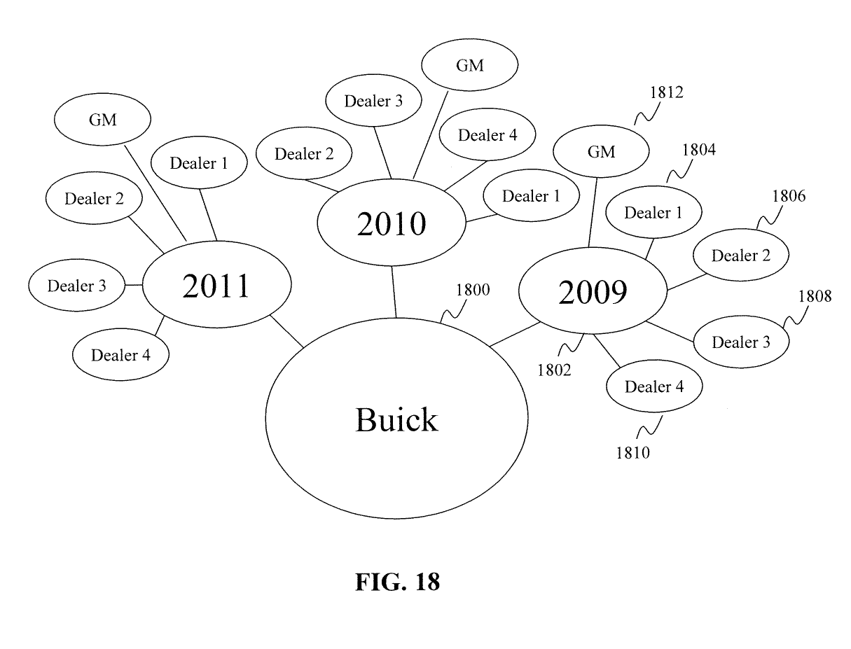

There may be different ways of invoking the campaign assembly package delivery module 118 to select a suitable campaign AP and its corresponding pattern and deliver it to a user as a multimedia advertisement. In some embodiments, a campaign AP and its corresponding pattern may be selected and presented based on information related to the user who made the request, such as user profile, interests, preferences, etc., which are either directly received in the user-related data feed from a third-party marketing data provider or identified and fed back by the user behavior targeting module 120. In some embodiment, an actionable indicator associated with a campaign AP may be used for activating the delivery of the associated campaign AP and its corresponding pattern In one example, the actionable indicator may be a simplified uniform resource locator (URL) transmitted through an e-mail delivered to the user, a webpage visited by the user, an SMS sent to the user, or any other way a user may find a URL. The simplified URL will be described in detail with respect to FIGS. 18-20.

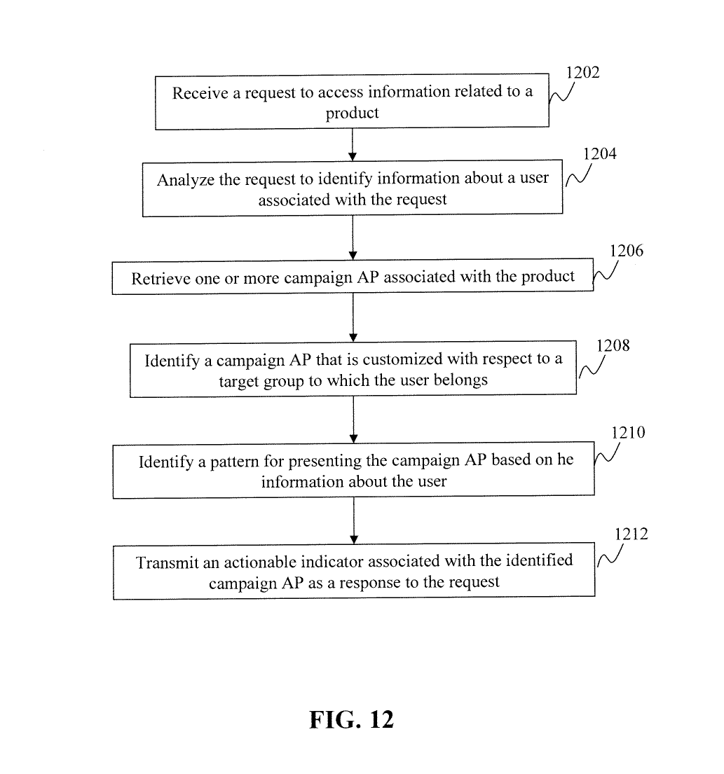

FIG. 12 is a flowchart of an exemplary process of the campaign assembly package delivery module 118 according to an embodiment of the present teaching. Starting from step 1202, a request to access information about a product is received. The information may include, for example, specifications and descriptions of the products or services, promotion related to the products or services, offers and incentives related to the products or services, campaign materials with respect to the products or services, and any other information relevant to the products or services. At step 1204, the request is analyzed to identify information about the user who made the request. Moving to step 1206, one or more campaign APs associated with the product are retrieved assuming such campaign APs have already been generated for the product. At step 1208, a campaign AP customized with respect to a target group to which the user belongs is identified. For example, a comparison may be made between the information about the user and the characterization of the target group associated with each retrieved campaign AP for the product. The identified campaign AP corresponds to one for which the characterization of the target group associated with the identified campaign AP is the most consistent with the information about the user. If it is determined that none of the target groups associated with each retrieved campaign AP is substantially similar to the information about the user, a new campaign AP for the product may be constructed online for the user. Moving to step 1210, a pattern that controls the presentation of the identified campaign AP is also identified based on the information about the user. At step 1212, an actionable indicator associated with the identified campaign AP, such as a simplified URL, is transmitted to the user as a response to the request. The actionable indicator is to be used to activate the presentation of the identified campaign AP, for example, on a webpage, to the user.

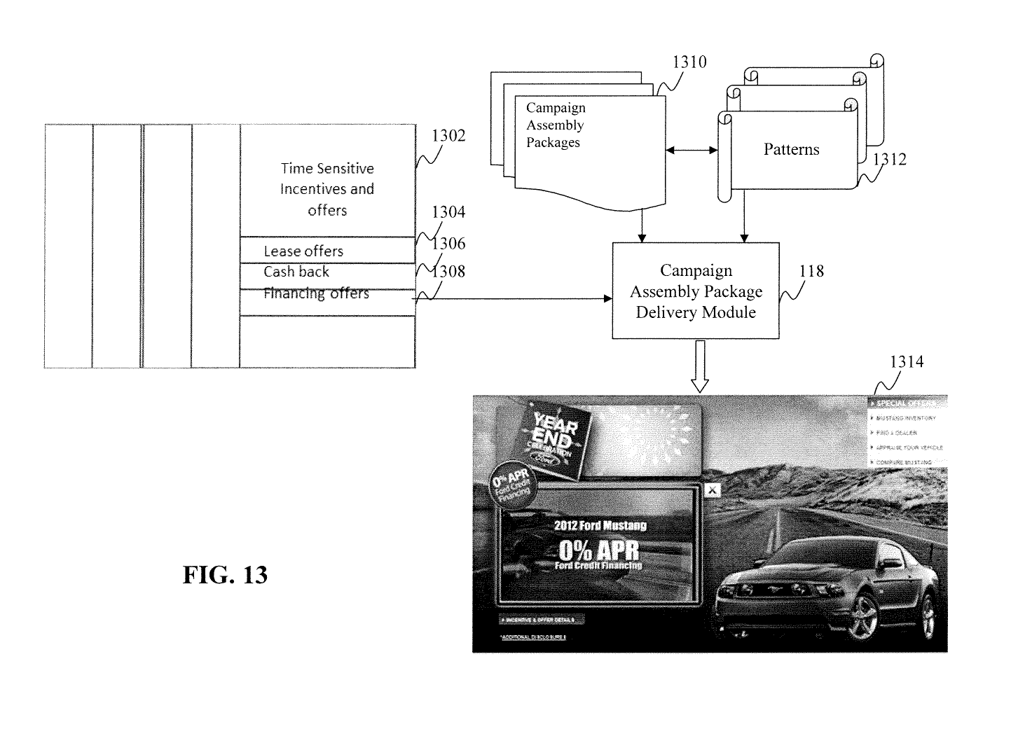

FIG. 13 illustrates an exemplary delivery of categorized data in a campaign AP to targeted audience in the form of a multimedia webpage based on patterns according to an embodiment of the present teaching. In this embodiment, data feed information may be sorted into different categories. That is, data entering the system 108 by the data feed may be reworked and normalized to fit various campaign APs and/or patterns. For example, the system 108 may classify a promotion as a time sensitive promotion 1302, a lease promotion 1304, a cash back promotion 1306, or a financing promotion 1308. When constructing the campaign APs the constructor 900 may construct the patterns, e.g., selecting the layout and form of the webpage, based on the type of promotion. The layout may include the position of items on the page, the colors of items on the page, the types of graphics on the page, etc. In the example shown in FIG. 13, a financing offer 1308 is made. A campaign AP 1310 and a corresponding pattern 1312 are selected by the campaign assembly package delivery module 118 and presented as a multimedia webpage 1314 based on the financing offer 1308. On the multimedia webpage 1314, digital content about the financing offer 1308, such as the video clip and picture of “0% APR financing offer,” the logo of the manufacture (Ford), and the background image showing the promoted product (2012 Ford Mustang), are displayed in a manner in accordance with the pattern 1312.

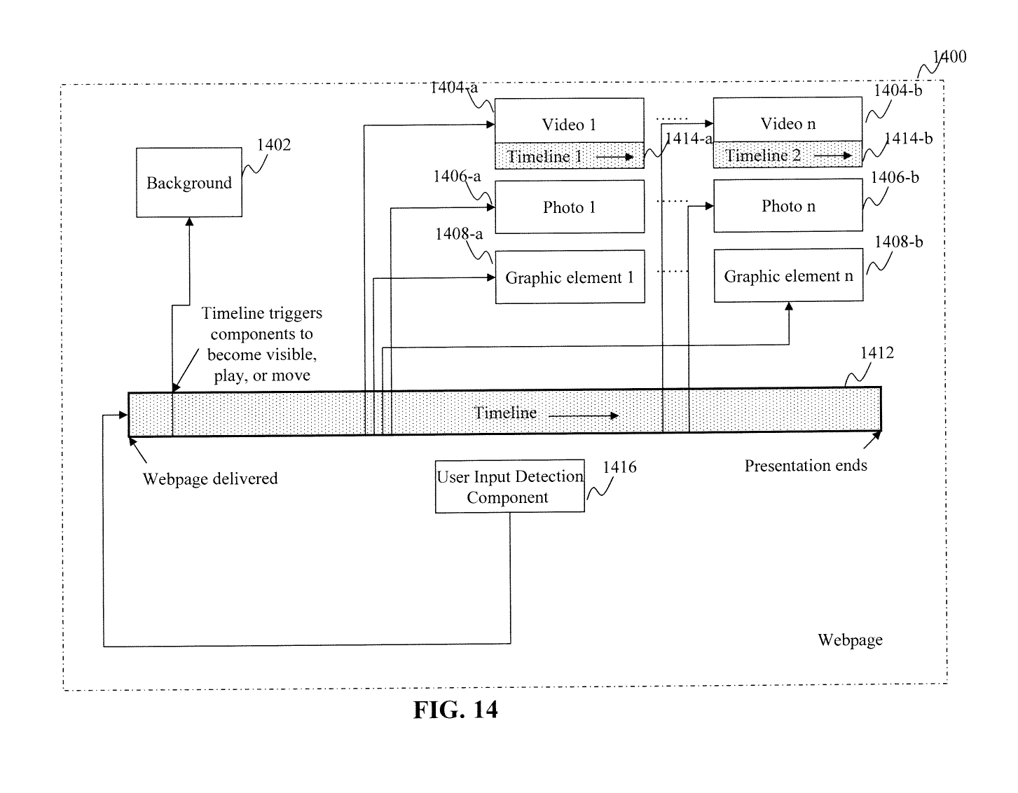

FIG. 14 illustrates exemplary components on a multimedia webpage built based on a campaign AP and corresponding pattern according to an embodiment of the present teaching. The multimedia webpage 1400 may include digital content from a campaign AP, such as background 1402, one or more video clips 1404-a, 140-4b, one or more photos 1406-a, 1406-b, and one or more graphic elements 1408-a, 1408-b. The organization and presentation of the components on the webpage 1400 are controlled by the corresponding pattern. The pattern may include a timeline 1412 for the webpage 1400. The timeline 1412 indicates the time sequence and manner in which the digital content to be presented. For example, after the webpage 1400 is loaded, the timeline 1412 may indicate that the background 1402 should be displayed first. A first trigger in the timeline 1412 may cause the background 1402 to be displayed. A second trigger in the timeline 1412 may cause video 1 1404-a to be displayed and played. Other triggers in the timeline 1412 may cause other content to be invoked. In addition to the timeline 1412 for the webpage 1400, in this embodiment, some of the components, such as the video clips 1404-a, 1404-b may have their own timelines 1414-a, 1414-b, each of which controlling the timing of the individual video clips 1404-a, 1404-b, respectively. In other words, multiple timelines may be included in a pattern for the same webpage.

A user input detection component 1416 on the webpage 1400 may detect the user input with respect to any components on the webpage 1400, for example, whether the user clicks on a button on the webpage 1400. The user input may cause the current position in the timeline 1412 to be changed. The display then may continue from the changed position in the timeline 1412. In some embodiments, the user input detection component 1416 may cause a new webpage to be loaded and displayed, new functionalities to be invoked, for example, a chat, or any other action possible from a webpage and compatible with embodiments of the present teaching.

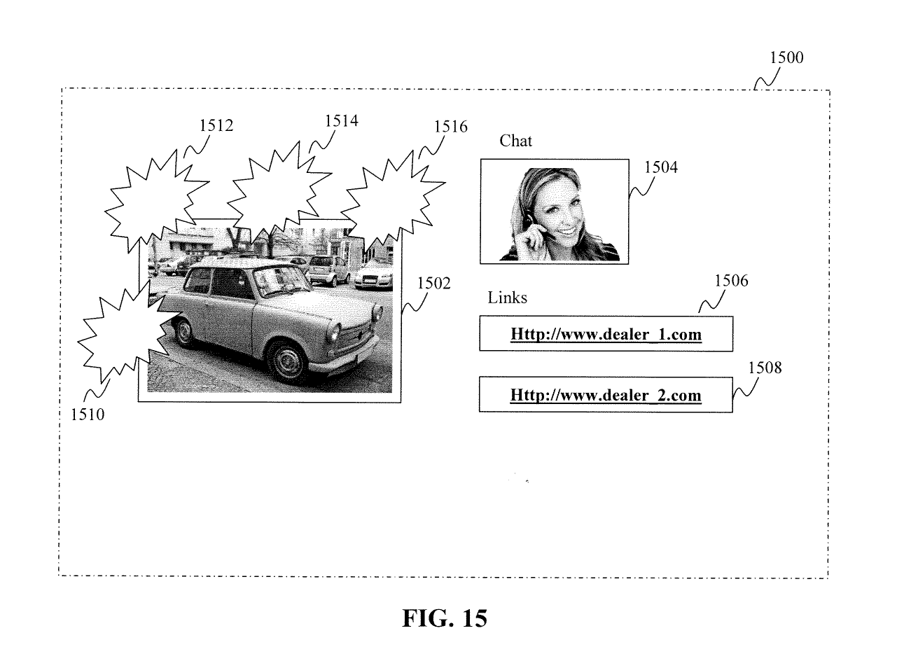

FIG. 15 illustrates an exemplary multimedia webpage built based on a campaign AP and corresponding pattern according to an embodiment of the present teaching. The multimedia webpage 1500 includes, for example, a video clip 1502 of a classic car for sale, a chat line 1504 for a user to chat with a representative about the classic car, links to dealers selling the classic car 1506, 1508, and promotions 1510, 1512, 1514, 1516 for the classic car. For example, a financing offer may be displayed as an image 1510, a graphic text 1512, an animation 1514, and a video clip 1516, around the video clip 1502 of the classic car.

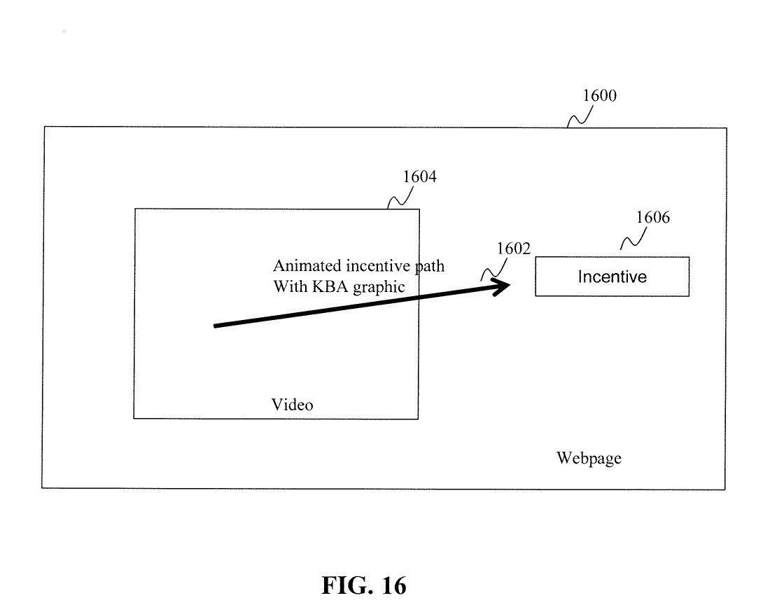

FIG. 16 illustrates an exemplary animated incentive path on a webpage according to an embodiment of the present teaching. An animated incentive path 1602 may be part of the information for controlling presentation of a campaign AP in a corresponding pattern. The animated incentive path 1602 may allow for creating and optimizing users' engagement with product providers' promotions through graphically animated motion paths to key buying activity (KBA) links using an invisible player on the webpage 1600. The animated incentive path 1602 in this embodiment allows a visual link to be made between components on the webpage 1600 from a campaign AP. The visual link may be made by moving a portion of one component on the webpage 1600 to another component across the webpage 1600. In this embodiment, as a video clip 1604 is being played, a portion of the video 1604 may appear to be drawn out of the video 1604 and moved to a clickable “Incentive” button 1606. The video 1604 in this embodiment includes a video incentive graphic and an animated incentive path 1602 with a KBA associated with the video 1604. When the webpage 1600 is loaded, the video 1604 starts to play. At some point, the matching video incentive graphic is then called out of the database according to the feed information as part of a campaign AP and is played in accordance with the corresponding pattern. The matching video incentive graphic is animated on top of or outside the video 1604 by an invisible player according to the pre-determined timings in the corresponding pattern. The matching video incentive graphic appears to move across the webpage 1600 to the “Incentive” button 1606.

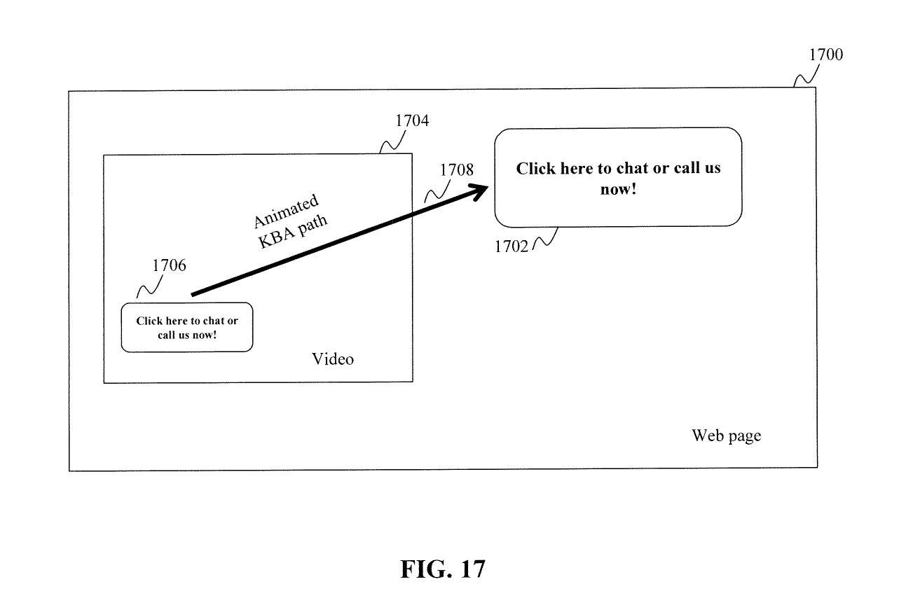

FIG. 17 illustrates another exemplary animated incentive path on a webpage according to an embodiment of the present teaching. FIG. 17 illustrates a “click here to chat or call us now!” button 1702 on the webpage 1700, outside the area of a video 1704. At some point during the playback of the video 1704, a second video or graphic is displayed on top of the video 1704. The second video or graphic has an image of “click here to chat or call now us!” button 1706. As the video 1704 plays, the image of “click here to chat or call now us!” button 1706 moves across the webpage 1700 along an animated incentive path 1708 to the position of “click here to chat or call now us!” button 1702. When the image 1706 reaches the position, the video 1704 finishes and becomes transparent, revealing the “click here to chat or call now us!” button 1702. Thus, the eyes of a user are drawn from the video 1704 to the button 1702 through the animated incentive path 1708.

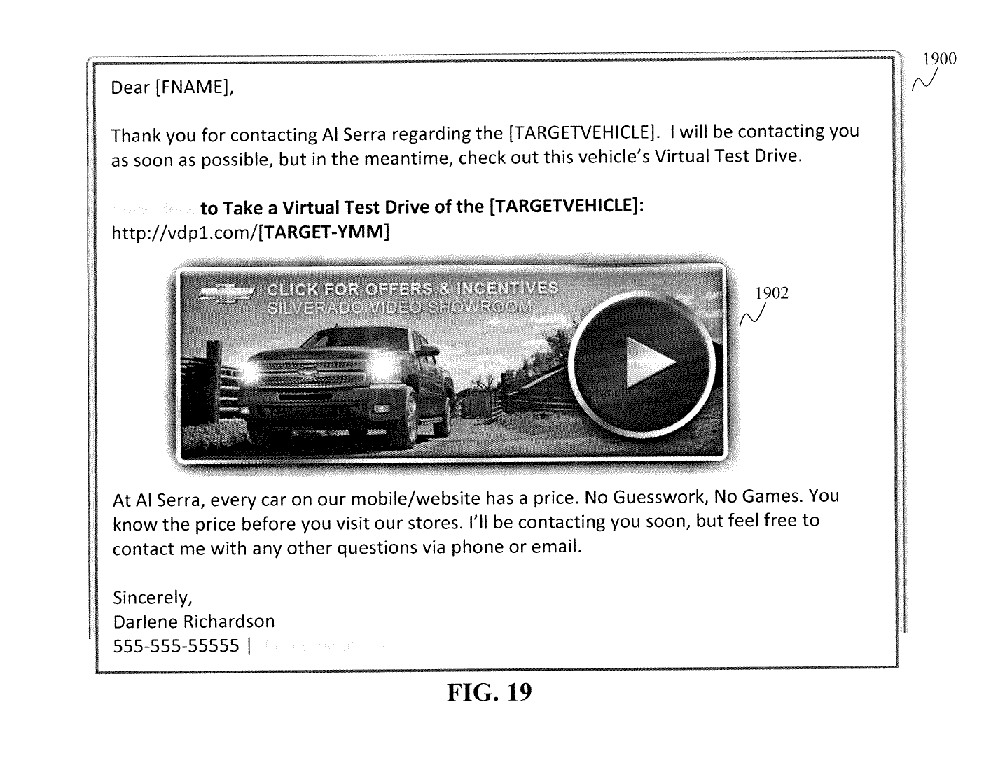

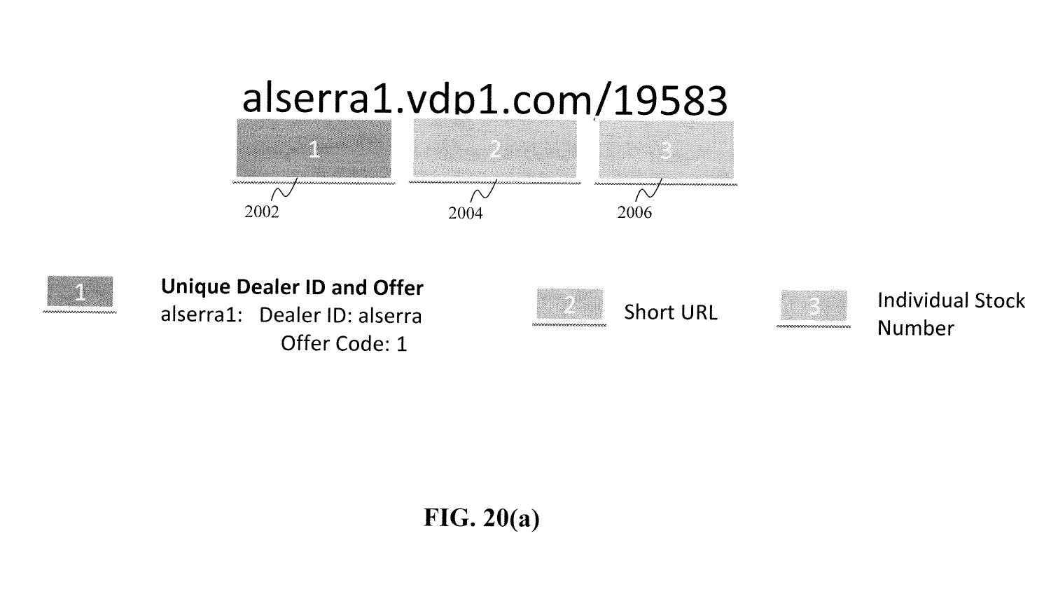

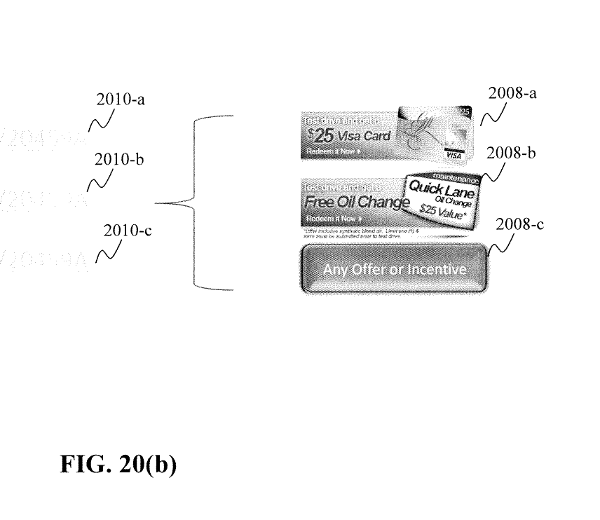

FIG. 18 illustrates an exemplary simplified URL according to an embodiment of the present teaching. As mentioned before, a simplified URL is one example of an actionable indicator used to activate the presentation of a campaign AP. In some embodiments, some campaigns (e.g., print campaigns, e-mail campaigns, direct mail campaigns, etc.) may have a need to target very specifically based on known user interest and intent. The simplified URL may provide a rule-based structure that gives campaign producers the ability to independently derive URLs for specific advertisements based on parameters that are appropriately added into the URL string, as will be described in detail in FIGS. 20(a) and 20(b). Campaign producers then may provide highly targeted, specific URLs in their direct mail or e-mail campaigns by merging the parameters into the URL structure, as will be described in detail in FIG. 19. With the simplified URL, campaign providers can promote as their call to action a large number of highly targeted and customized advertisements. Campaign producers can reliably and independently create the URLs in real time, assuming the campaign assembly package delivery module 118 has access to the same list of URL parameters, and they can mass customize the URLs in their mails or e-mails using any known mail-merge techniques.

The simplified URL may be, for example, http://vdp1.com/[TARGET-YMM]. “vdp1.com” indicates the base website of a server, and “/[TARGET-YMM]” indicates a product and the year and month when the product is made. The simplified URL may be used to call any campaign AP associated with the product indicated by the simplified URL. For example, if the target is a Buick car, then the campaign assembly package delivery module 118 may receive a URL request of http://vdp1.com/Buick. The campaign assembly package delivery module 118 then may search for a campaign AP based on the URL in the data structure shown in FIG. 18. The data structure includes a root node 1800 indicating all campaign APs for Buick cars. In the next level of the data structure, the campaign APs are organized according to the year in which the Buick cars are made. If the year is also specified in the simplified URL, e.g., http://vdp1.com/Buick-2009, the campaign assembly package delivery module 118 may be able to further narrow the campaign APs to the second level node 1802 for all the Buick cars made in 2009. In the data structure in this embodiment, campaign APs may be organized in the third level based on the dealers and/or manufacturer. For example, in the third level of the data structure, nodes 1804, 1806, 1808, 1810 may represent campaign APs for dealers selling the 2009 Buick cars, and the node 1812 may represent the campaign AP for the manufacture (GM) of the 2009 Buick cars. If the dealer of the manufacture is also specified in the simplified URL, e.g., http://vdp1.com/Buick-2009-dealer1, the campaign assembly package delivery module 118 may be able to further narrow the campaign APs to the third level node 1804. The campaign APs for Buick cars made in other years, e.g., 2010 and 2011, may be similarly structured in the data structure in this embodiment.

FIG. 19 illustrates an exemplary targeted e-mail with a simplified URL according to an embodiment of the presenting teaching. In the exemplary e-mail 1900, a simplified URL is attached to the graphic 1902 indicating “click for offers & incentives,” and the play symbol. If the user clicks on the graphic 1902, the simplified URL is requested. The e-mail 1900 may be a generic e-mail which needs to be merged with information related to the targeted customers and product promotions to replace instances, such as [FNAME] with the name of the e-mail recipient and [TARGETVEHICLE] with the name of the car. The e-mail merging may be done by, for example, by a customer relationship management system (CRM) of a dealer, manufacturer, or any other entity having a relationship with the customer. Clicking on the graphic 1902 in the e-mail 1900 may result in displaying the webpage of “Village Chevrolet” (the underlying URL is http://vdp1.com/2012-Chevrolet-Sliverado). Clicking the graphic 1902 in the e-mail 1900 may cause a campaign AP and its corresponding pattern related to the Silverado car and the dealer who sent the e-mail 1900 to be identified and used for building a multimedia advertisement.

FIGS. 20(a) and 20(b) illustrate an exemplary structure of simplified URLs for different promotions according to an embodiment of the present teaching. In this embodiment, the simplified URL may include three elements 2002, 2004, 2006 arranged in a pre-defined sequence. The first element 2002 may be configured to provide a first identification representing a locale. In this example, the first element represents a unique ID of a dealer who offers the promotions, e.g., “alserra.” The second element 2004 may be configured to provide a second identification representing a source to access information related to a product made available at a locale. In this example, the second element 2004 represents a short URL directed to a base website of a server, e.g., “vdp1.com.” The third element 2006 may be configured to provide a third identification representing a product. In this example, the third element 2006 represents an individual stock number of a product, e.g., “19583.” The combination of the first, second, and third elements 2002, 2004, 2006 in the pre-defined sequence thus identifies a specific source for information, i.e., a campaign AP and its corresponding pattern stored in the server, related to a specific product made available at a specific locale.

A campaign producer may provide different versions of the requested specific information, i.e., campaign APs and their corresponding patterns, in the base website of the server. As shown in FIG. 20(b), three versions of campaign APs for promotions, i.e., a cash offer 2008-a, a free oil change offer 2008-b, and any other offers 2008-c, are made available by the dealer “alserra” for a car having a stock number of “20459A.” Three simplified URLs 2010-a, 2010-b, 2010-c, may be used for identifying each version of campaign APs and their corresponding patterns respectively by changing the offer code in the first element 2002 of the simplified URL. Thus, using the simplified URL, dealers may rapidly make up a new version of promotion, and the promotion may be available to customers of the dealer customized for products that the customer is likely most interested in. As mentioned before, the user who made the request of the simplified URL may be considered as another source of information in determining which version of the campaign APs should be selected and provided. For example, if the user is a customer who regularly does oil change at the dealer of “alserra,” then the second version of promotions, i.e., free oil change offer 2008-b, may be selected and delivered to the user in the form of the second simplified URL 2010-b.

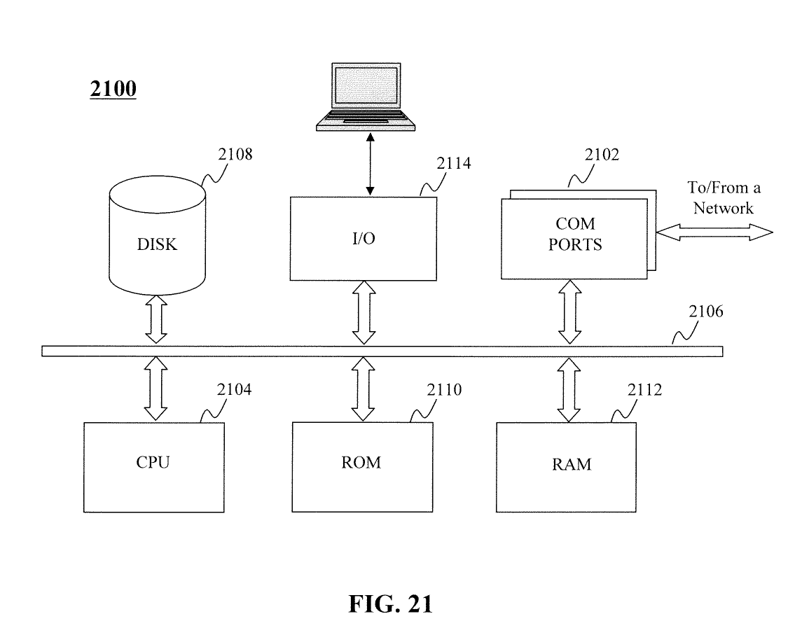

FIG. 21 illustrates a general computer architecture on which the present teaching can be implemented. The computer 2100, for example, includes COM ports 2102 connected to and from a network connected thereto to facilitate data communications. The computer 2100 also includes a central processing unit (CPU) 2104, in the form of one or more processors, for executing program instructions. The exemplary computer platform includes an internal communication bus 2106, program storage and data storage of different forms, e.g., disk 2108, read only memory (ROM) 2110, or random access memory (RAM) 2112, for various data files to be processed and/or communicated by the computer, as well as possibly program instructions to be executed by the CPU. The computer 2100 also includes an I/O component 2114, supporting input/output flows between the computer and other components therein such as user interface elements. The computer 2100 may also receive programming and data via network communications.

The general computer architecture may be a general-purpose computer or a special purpose computer. This computer can be used to implement any components of the system 108 described herein. For example, the data feed processor 110, the offline asset constructor 114, the online asset constructor 116, the campaign assembly package delivery module 118, and the behavior targeting module 120 may be implemented on a computer such as computer, via its hardware, software program, firmware, or a combination thereof. Although only one such computer is shown, for convenience, the computer functions relating to the system 108 may be implemented in a distributed fashion on a number of similar platforms, to distribute the processing load.

Hence, aspects of the methods for creating data-driven multimedia advertisements for dynamically targeted audience, as outlined above, may be embodied in programming. Program aspects of the technology may be thought of as “products” or “articles of manufacturer” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the service provider or other service providers into the hardware platform(s) of a computing environment or other system implementing a computing environment or similar functionalities in connection with the marketing system. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium, or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables, copper wire, and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media, therefore, include, for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teaching is amenable to a variety of modifications and/or enhancements. For example, although the implementation of various components described above may be embodied in a hardware device, it can also be implemented as a software only solution—e.g., an installation on an existing server. In addition, systems and their components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teaching.

We claim:

1. A method implemented on a computer having at least one processor, storage, and communication platform for online advertising with respect to target groups, comprising:
receiving data feed from one or more sources, each of which is associated with at least one product;
analyzing the data feed from each source to identify information related to any of the at least one product associated therewith;
generating, with respect to each product, a set of one or more campaign assembly packages (APs), each of which is directed to a target group, based on information characterizing the target group;
generating, with respect to each campaign AP, a pattern to be used for presenting the campaign AP to a target group associated with the campaign AP; and
storing the one or more campaign APs for each product and their corresponding patterns in a storage for future use.

2. The method of claim 1, wherein the campaign AP comprises one or more pieces of content including at least one of:
video clips;
photos;
animations;
digital graphic elements;
thumbnail icons;
background images;
color palette information;
metadata information; and
product information.

3. The method of claim 2, wherein the pattern comprises information for controlling the presentation of the one or more pieces of content in each campaign AP, the information including at least one of:
size of a display area in which the one or more pieces of content are to be presented;
location and dimension in the display area in which each of the one or more pieces of content is to be presented;
timing at which each of the one or more pieces of content is to be presented;
duration for which each of the one or more pieces of content is to be presented;
font to be used to present each of the one or more pieces of content; and
color to be used to present each of the one or more pieces of content.

4. The method of claim 1, wherein the data feed comprises at least one of:
descriptions of the products;
promotions associated with the products;
advertisements on the products; and
campaign materials with respect to the products.

5. The method of claim 1, wherein the data feed comprises at least one of behavior targeting related information;
profiles of different social groups;
profiles based on demographics; and
information analytics derived from the commerce.

6. The method of claim 1, wherein the step of analyzing the data feed from each source includes associating information on a product from the data feed in terms of at least one of the following:
model of the product;
manufacturer of the product;
year in which the product is made;
locale in which the product is sold;
inventory availability of the product;
one or more features of the product; and
price range of the product.

7. The method of claim 2, wherein the step of generating a set of one or more campaign APs comprises:
determining a number of target groups and for each of the target groups;
retrieving the information characterizing the target group;
if the information characterizing the target group matches with some pieces of stored content, retrieving the stored content as the content for the campaign AP corresponding to the target group;
if the information characterizing the target group substantially matches with some pieces of stored content, modifying the stored content to generate one or more pieces of content for the campaign AP corresponding to the target group; and
if the information characterizing the target group does not match with any piece of stored content, creating one or more pieces of content for the campaign AP corresponding to the target group.

8. The method of claim 1, further comprising:
creating one or more uninstantiated actionable display items for each campaign AP, wherein the one or more uninstantiated actionable display items are created in accordance with the characterization of the corresponding target group.

9. The method of claim 8, wherein a uninstantiated actionable display item includes a clickable button.

10. The method of claim 1, wherein information characterizing a target group is obtained from a user data feed and generated by:
analyzing the user data feed to generate behavior targeting information;
creating a plurality of target groups based on a result of the analyzing;
generating the information characterizing each of the target groups that describes the preference of the targets within the group; and
storing the target groups and the information characterizing each target group for use in generating the one or more campaign APs in a manner that is appropriate with respect to the information characterizing the target group.

11. The method of claim 1, wherein the information characterizing a target group is obtained from a data feed related to a product and/or a promotion thereof

12. The method of claim 10, wherein each target group is identified from at least one of:
a data feed from a source related to a product and/or a promotion thereof; and
information related to one or more target groups stored in a behavior targeting information storage.

13. The method of claim 1, wherein the pattern is generated based on information characterizing a target group for which the campaign AP is created.

14. A system for online advertising with respect to target groups, comprising:
a data feed processor configured to:
receive data feed from one or more sources, each of which is associated with at least one product, and
analyze the data feed from each source to identify information related to any of the at least one product associated therewith;
a constructor configured to:
generate, with respect to each product, a set of one or more campaign APs, each of which is directed to a target group, based on information characterizing the target group, and
generate, with respect to each campaign AP, a pattern to be used for presenting the campaign AP to a target group associated with the campaign AP; and
a storage configured to store the one or more campaign APs for each product and their corresponding patterns for future use.

15. The system of claim 14, wherein the campaign AP comprises one or more pieces of content including at least one of:
video clips;
photos;
animations;
digital graphic elements;
thumbnail icons;
background images;
color palette information;
metadata information; and
product information.

16. The system of claim 15, wherein the pattern comprises information for controlling the presentation of the one or more pieces of content in each campaign AP, the information including at least one of:
size of a display area in which the one or more pieces of content are to be presented;
location and dimension in the display area in which each of the one or more pieces of content is to be presented;
timing at which each of the one or more pieces of content is to be presented;
duration for which each of the one or more pieces of content is to be presented;
font to be used to present each of the one or more pieces of content; and
color to be used to present each of the one or more pieces of content.

17. The system of claim 14, wherein the data feed comprises at least one of:
descriptions of the products;
promotions associated with the products;
advertisements on the products; and
campaign materials with respect to the products.

18. The system of claim 14, wherein the data feed comprises at least one of:
behavior targeting related information;
profiles of different social groups;
profiles based on demographics; and
information analytics derived from the commerce.

19. The system of claim 14, wherein the data feed processor is further configured to associate information on a product from the data feed in terms of at least one of the following:
model of the product;
manufacturer of the product;
year in which the product is made;
locale in which the product is sold;
inventory availability of the product;
one or more features of the product; and
price range of the product.

20. The system of claim 15, wherein the asset constructor is further configured to:
determine a number of target groups and for each of the target groups;
retrieve the characterization for the target group;
if the information characterizing the target group matches with some pieces of stored content, retrieve the stored content as the content for the campaign AP corresponding to the target group;
if the information characterizing the target group substantially matches with some pieces of stored content, modify the stored content to generate one or more pieces of content for the campaign AP corresponding to the target group; and
if the information characterizing the target group does not match with any pieces of stored content, create one or more pieces of content for the campaign AP corresponding to the target group.

21. The system of claim 14, wherein the constructor is further configured to:
create one or more uninstantiated actionable display items for each campaign AP, wherein the one or more uninstantiated actionable display items are created in accordance with the characterization of the corresponding target group.

22. The system of claim 21, wherein a uninstantiated actionable display item includes a clickable button.

23. The system of claim 14, further comprising a behavior targeting module configured to:
receive user data feed;
analyze the user data feed to generate behavior targeting information;
create a plurality of target groups based on a result of the analyzing; and
generate the information characterizing each of the target groups that describes the preference of the targets within the group; and
store the target groups and the information characterizing each target group for use in generating the one or more campaign APs in a manner that is appropriate with respect to the information characterizing the target group.

24. The system of claim 14, wherein the information characterizing a target group is obtained from a data feed related to a product and/or a promotion thereof.

25. The system of claim 23, wherein each target group is identified from at least one of:
a data feed from a source related to a product and/or a promotion thereof; and
information related to one or more target groups stored in a behavior targeting information storage.

26. The system of claim 14, wherein the pattern is generated based on information characterizing a target group for which the campaign AP is created.

27. A machine-readable tangible and non-transitory medium having information recorded thereon for online advertising with respect to target groups, wherein the information, when read by the machine, causes the machine to perform the following:
receiving data feed from one or more sources, each of which is associated with at least one product;
analyzing the data feed from each source to identify information related to any of the at least one product associated therewith;
generating, with respect to each product, a set of one or more campaign APs, each of which is directed to a target group, based on information characterizing the target group;
generating, with respect to each campaign AP, a pattern to be used for presenting the campaign AP to a target group associated with the campaign AP; and
storing the one or more campaign APs for each product and their corresponding patterns in a storage for future use.

28. The medium of claim 27, wherein the campaign AP comprises one or more pieces of content including at least one of:
video clips;
photos;
animation;
digital graphic elements;
thumbnail icons;
background images;
color palette information;
metadata information; and
product information.

29. The medium of claim 28, wherein the pattern comprises information for controlling the presentation of the one or more pieces of content in each campaign AP, the information including at least one of:
size of a display area in which the one or more pieces of content are to be presented;
location and dimension in the display area in which each of the one or more pieces of content is to be presented;
timing at which each of the one or more pieces of content is to be presented;
duration for which each of the one or more pieces of content is to be presented;
font to be used to present each of the one or more pieces of content; and
color to be used to present each of the one or more pieces of content.

30. The medium of claim 27, wherein the data feed comprises at least one of:
descriptions of the products;
promotions associated with the products;
advertisements on the products; and
campaign materials with respect to the products.

31. The medium of claim 27, wherein the data feed comprises at least one of:
behavior targeting related information;
profiles of different social groups;
profiles based on demographics; and
information analytics derived from the commerce.

32. The medium of claim 27, wherein the step of analyzing the data feed from each source includes associating information on a product from the data feed in terms of at least one of the following:
model of the product;
manufacturer of the product;
year in which the product is made;
locale in which the product is sold;
inventory availability of the product;
one or more features of the product; and
price range of the product.

33. The medium of claim 27, wherein the step of generating a set of one or more campaign APs comprises:
determining a number of target groups and for each of the target groups;
retrieving the information characterizing the target group;
if the information characterizing the target group matches with some pieces of stored content, retrieving the stored content as the content for the campaign AP corresponding to the target group;
if the information characterizing the target group substantially matches with some pieces of stored content, modifying the stored content to generate one or more pieces of content for the campaign AP corresponding to the target group; and
if the information characterizing the target group does not match with any pieces of stored content, creating one or more pieces of content for the campaign AP corresponding to the target group.

34. The medium of claim 27, further comprising:
creating one or more uninstantiated actionable display items for each campaign AP, wherein the one or more uninstantiated actionable display items are created in accordance with the characterization of the corresponding target group.

35. The medium of claim 34, wherein a uninstantiated actionable display item includes a clickable button.

36. The medium of claim 27, wherein information characterizing a target group is obtained from a user data feed and generated by:
analyzing the user data feed to generate behavior targeting information;
creating a plurality of target groups based on a result of the analyzing; and
generating information characterizing each of the target groups that describes the preference of the targets within the group; and
storing the target groups and the information characterizing each target group for use in generating the one or more campaign APs in a manner that is appropriate with respect to the information characterizing the target group.

37. The medium of claim 27, wherein the information characterizing a target group is obtained from a data feed related to a product and/or a promotion thereof.

38. The medium of claim 36, wherein each target group is identified from at least one of:
a data feed from a source related to a product and/or a promotion thereof; and
information related to one or more target groups stored in a behavior targeting information storage.

39. The medium of claim 27, wherein the pattern is generated based on information characterizing a target group for which the campaign AP is created.

40. A method implemented on a computer having at least one processor, storage, and communication platform for online advertising with respect to target groups, comprising:
receiving a request to access information related to a product;
analyzing the request to identify information about a user associated with the request;
retrieving one or more campaign APs associated with the product;
identifying a campaign AP that is customized with respect to a target group to which the user is considered to belong, determined based on the information about the user;
identifying a pattern for presenting the identified campaign AP based on the information about the user; and
transmitting an actionable indicator associated with the identified campaign AP as a response to the request, wherein the actionable indicator is to be used to activate the presentation of the identified campaign AP.

41. The method of claim 40, wherein the step of identifying a campaign AP comprises:
searching, in a storage, previously stored campaign APs; and
selecting a campaign AP based on a comparison between the information about the user and a characterization of a target group associated with each campaign AP, wherein
the selected campaign AP corresponds to one for which the characterization of the target group associated with the selected campaign AP is the most consistent with the information about the user.

42. The method of claim 40, wherein the step of identifying a campaign AP comprises:
determining a number of target groups associated with the retrieved campaign APs and for each of the target groups:
determining whether the characterization of the target group is similar to the information about the user;
if it is substantially similar, retrieving the corresponding AP corresponding to the target group and previously stored as the identified campaign AP; and
if no target group is substantially similar, creating one or more pieces of content to generate a campaign AP for the user.

43. The method of claim 40, wherein the identified campaign AP includes one or more patterns, wherein each pattern includes information for controlling the presentation of the one or more rich media items associated with the AP.

44. The method of claim 40, wherein the campaign AP comprises one or more pieces of content including at least one of:
video clips;
photos;
animation;
digital graphic elements;
thumbnail icons;
background images;
color palette information;
metadata information; and
product information.

45. The method of claim 43, wherein the pattern comprises information for controlling the presentation of the one or more pieces of content in each campaign AP, the information including at least one of:
size of a display area in which the one or more pieces of content are to be presented;
location and dimension in the display area in which each of the one or more pieces of content is to be presented;
timing at which each of the one or more pieces of content is to be presented;
duration for which each of the one or more pieces of content is to be presented;
font to be used to present each of the one or more pieces of content; and
color to be used to present each of the one or more pieces of content.

46. The method of claim 40, wherein the actionable indicator comprise a simplified uniform resource locator (URL).

47. An integrated locator structure, comprising:
a first element configured for providing a first identification representing a locale;
a second element configured for providing a second identification representing a first source to access information related to a product made available at a locale; and
a third element configured for providing a third identification representing a product, wherein
a combination of the first, second, and third elements in a pre-defined sequence identifies a specific source for information related to a specific product made available at a specific locale,
the specific source provides different versions of information related to the specific product made available at the specific locale, and
a version to be accessible corresponding to a particular request is determined based on a second source from where the request is made.

48. A method for providing information, comprising:
receiving a request having a first element corresponding to a first identification representing a locale, a second element corresponding to a second identification representing a first source to access information related to a product made available at a locale, and a third element corresponding to a third identification representing a product;
analyzing the first, second, and third elements to identify a requested specific type of information related to a specific product made available at a specific locale;
identifying a specific source where the requested specific type of information is accessible, where the specific source provides different versions of requested specific information related to the specific product made available at the specific locale;
obtaining information associated with a second source where the request is sent; and
determining a version of the requested specific information to be made accessible customized for the request based on the information associated with the second source.
